(19) United States
(12) Patent Application Publication
(10) Pub. No.: US 2025/0323242 A1
(43) Pub. Date: Oct. 16, 2025

(54) ZINC SECONDARY BATTERY COMPOSITE ANODE, METHOD FOR MANUFACTURING SAME, AND SECONDARY BATTERY INCLUDING ZINC SECONDARY BATTERY COMPOSITE ANODE

(71) Applicant: KOREA INSTITUTE OF ENERGY RESEARCH, Daejeon (KR)

(72) Inventors: Jung Joon YOO, Daejeon (KR); Jung Hyun LEE, Daejeon (KR); Jeong Hun BAEK, Daejeon (KR); Bum Jin KIM, Daejeon (KR); Se Gi BYUN, Daejeon (KR); Sang Hui KANG, Daejeon (KR); Seung Ho LEE, Pyeongtaek-si (KR)

(73) Assignee: KOREA INSTITUTE OF ENERGY RESEARCH, Daejeon (KR)

(21) Appl. No.: 19/175,847

(22) Filed: Apr. 10, 2025

(30) Foreign Application Priority Data
Apr. 11, 2024 (KR) 10-2024-0048485
Mar. 31, 2025 (KR) 10-2025-0041206

(51) Int. Cl. H01M 4/134; H01M 4/62; H01M 10/38; H01M 50/497

(52) U.S. Cl. CPC H01M 4/134; H01M 4/623; H01M 10/38; H01M 50/497

(57) ABSTRACT

According to an example of the present invention, provided are a secondary battery composite anode, including: a metal layer that includes a first metal; and a liquid metal coating layer that is formed on the metal layer and includes a metal different from the first metal, in which the metal different from the first metal is included in a grain boundary of the first metal, a method for manufacturing the same, a secondary battery including the composite anode.

### BACKGROUND OF THE INVENTION

### Field of the Invention

The present invention relates to a secondary battery composite anode, and more particularly, to a secondary battery composite anode having significantly improved corrosion characteristics, a method for manufacturing the same, and a secondary battery including the anode.

### Description of the Related Art

Zinc secondary batteries (Zinc-Ion Battery, ZIB) are attracting attention as a next-generation secondary battery due to advantages such as high theoretical capacity, excellent stability, and economic efficiency. In particular, aqueous zinc batteries have lower fire and explosion risks and have environmentally friendly characteristics compared to lithium secondary batteries by using an aqueous electrolyte. However, the currently commercialized zinc-based anodes have several fundamental limitations, and if these problems are not solved, it will be difficult to develop long-life and high-performance zinc secondary batteries.

Zinc (Zn) metal that is generally used as the anode of an aqueous zinc battery naturally undergoes a corrosion reaction when exposed to a weakly acidic electrolyte. This corrosion reaction makes the Zn surface uneven to create an environment in which the current is easily concentrated at a specific point, whereby OH⁻ ions formed along with a hydrogen evolution reaction (HER) form insulating byproducts (Zn(OH)₆SO₄, ZHS) on the Zn surface. These byproducts hinder the deposition and dissolution processes of Zn to ultimately promote the formation of Zn dendrites. Zn dendrites not only deteriorate the performance of the battery, but also cause internal short-circuits, and act as one of the major factors threatening the stability of the battery.

In addition, when a vanadium oxide (V₂O₅)-based cathode material is used, an additional problem occurs in which a byproduct in the form of a mixture of Zn, V, and O is formed on the cathode surface in a weakly acidic electrolyte. This by-product formation reaction gradually decreases the pH of the electrolyte, and when it decreases below a certain level, the reaction stops. However, when a Zn anode that corrodes is used together, the pH of the electrolyte increases back due to the HER reaction, and this causes the byproduct formation reaction at the anode and cathode to occur repeatedly, thereby resulting in a decrease in the performance of the battery.

Up to date, the development of an anode material that does not corrode even under weakly acidic conditions has emerged as an essential task to be solved. In previous studies, Zn₃Hg alloys are known as anode materials with excellent corrosion resistance, but actual commercialization is difficult due to the toxicity problem of mercury (Hg). Therefore, the development of a new anode material that is non-toxic and does not corrode even in a weakly acidic environment is urgent.

Accordingly, the inventors of the present invention developed a composite anode material using a non-toxic liquid metal coating layer, and confirmed that the corrosion resistance is improved compared to existing Zn, and at the same time, dendrites are not formed during the Zn deposition process. As a result of the long-life test, stable operation for a life span tens of times longer than that of a general Zn anode was confirmed, thereby leading to the present invention.

### SUMMARY OF THE INVENTION

The present invention has been devised to solve the above-mentioned problems, and one example of the present invention provides a secondary battery composite anode.

Also, another example of the present invention provides a method for manufacturing a secondary battery composite anode.

Also, another example of the present invention provides a secondary battery including a secondary battery composite anode.

The technical problems to be solved by the present invention are not limited to the technical problems described above, and other technical problems not described can be clearly understood by those skilled in the art to which the present invention belongs from the description below.

As a technical means for solving the above-described technical problem, one aspect of the present invention provides a secondary battery composite anode, including:

a metal layer that includes a first metal; and a liquid metal coating layer that is formed on the metal layer and includes a metal different from the first metal, in which the metal different from the first metal is included in a grain boundary of the first metal.

The first metal is limited to a metal used in a secondary battery, and the metal may be at least one selected from lithium, zinc, sodium, potassium, magnesium, calcium, or aluminum.

The metal different from the first metal of the liquid metal coating layer may be at least two selected from the group consisting of gallium (Ga), indium (In), tin (Sn), sodium (Na), lead (Pb), bismuth (Bi), potassium (K), and mercury (Hg).

The liquid metal may be Galinstan.

A protective layer formed on the liquid metal coating layer may be further included.

The protective layer may be formed with a liquid metal.

An outer layer may be further included on the protective layer.

The outer layer may be formed with an ion-permeable polymer.

The ion-permeable polymer may be at least one selected from polyvinyl alcohol (PVA), polyacrylamide (PAM), poly(styrene sulfonate) (PSS), polyethylene oxide (PEO), polyacrylic acid-based gel (Carbopol), polydopamine (PDA), polyaniline (PANI), polyimide (PI), polypyrrole (PPy), polyvinylidene fluoride (PVDF), polyvinylidene fluoride-hexafluoropropylene (PVDF-HFP), polyethylene glycol (PEG), polyvinylpyrrolidone (PVP), poly(2-hydroxyethyl methacrylate) (PHEMA), polyacrylic acid (PAA), carboxymethyl cellulose (CMC), polytetrafluoroethylene (PTFE), polymethyl methacrylate (PMMA), polyethyleneimine (PEI), chitosan, poly(2-acrylamido-2-methylpropanesulfonic acid) (PAMPS), sodium alginate, polystyrene (PS), polypropylene (PP), polycarbonate (PC), and polycaprolactam (PA6).

A thickness of a byproduct layer formed at a topmost portion formed after the secondary battery composite anode is immersed in an electrolyte for 10 days may be less than 7 μm on average.

Another aspect of the present invention provides a method for manufacturing a secondary battery composite anode, including: a step of coating the metal layer with a liquid metal including a metal different from the first metal; a step of scraping the coated liquid metal; and a step of wiping a surface of the scraped metal layer to form a liquid metal coating layer.

After the step of wiping the surface of the scraped metal layer to form the liquid metal layer, a step of forming a protective layer on the liquid metal coating layer may be further included.

After the step of forming the protective layer on the liquid metal coating layer, a step of forming an outer layer formed with an ion-permeable polymer on the protective layer may be further included.

Another aspect of the present invention provides
a secondary battery including a cathode; the anode; and an electrolyte.

### BRIEF DESCRIPTION OF THE DRAWINGS

FIG. 1 is a schematic diagram showing a method for manufacturing a composite anode material according to one embodiment of the present invention;

FIG. 2 is a photograph showing a surface of a composite anode after scraping according to the method for manufacturing a composite anode material according to one embodiment of the present invention;

FIG. 3 is a photograph showing a surface of a composite anode after wiping according to the method for manufacturing a composite anode material according to one embodiment of the present invention;

FIG. 4 shows an SEM image of a surface of a zinc anode material of a comparative example;

FIG. 5 shows an EDS analysis image of the surface of the zinc anode material of a comparative example;

FIG. 6 shows an SEM image of a cross-section of the zinc anode material of a comparative example;

FIG. 7 shows an EDS analysis image of the cross-section of the zinc anode material of a comparative example;

FIG. 8 shows an SEM image and an EDS analysis image of the surface of the zinc composite anode material according to one embodiment of the present invention;

FIG. 9 shows an SEM image of the cross-section of the zinc composite anode material according to one embodiment of the present invention;

FIG. 10 shows an SEM image and an EDS analysis image of the cross-section of the zinc composite anode material according to one embodiment of the present invention;

FIG. 11 shows an XPS spectrum of the surface of the zinc composite anode material according to one embodiment of the present invention;

FIG. 12 shows an SEM image obtained by examining corrosion characteristics of the surface of the zinc anode material of a comparative example;

FIG. 13 shows an SEM image and an EDS analysis image obtained by examining corrosion characteristics of the surface of the zinc anode material of a comparative example;

FIG. 14 shows an SEM image obtained by examining the corrosion characteristics of the cross-section of the zinc anode material of a comparative example;

FIG. 15 shows an SEM image obtained by examining the corrosion characteristics of the surface of the zinc anode material of the zinc composite anode material according to one embodiment of the present invention;

FIG. 16 shows an SEM image and an EDS analysis image obtained by examining the corrosion characteristics of the surface of the zinc anode material of the zinc composite anode material according to one embodiment of the present invention;

FIG. 17 shows an SEM image obtained by examining the corrosion characteristics of the cross-section of the zinc anode material of the zinc composite anode material according to one embodiment of the present invention;

FIG. 18 shows a Tafel plot of the zinc composite anode material according to a comparative example and one embodiment of the present invention;

FIG. 19 shows a symmetric battery configured in the form of a 2032 coin cell;

FIG. 20 shows results of evaluating the repeated Zn deposition/dissolution behavior of a Zn electrode and a GalinZn electrode under conditions of 0.5 mA cm⁻² and 0.5 mAh cm⁻²;

FIG. 21 shows voltage changes of anodes of one embodiment and a comparative example of the present application for initial approximately four hours, respectively;

FIG. 22 shows results obtained by observing the repeated Zn deposition/dissolution behavior of a Zn electrode (black) and a GalinZn electrode (red) under conditions of 0.5 mA cm⁻² and 0.5 mAh cm⁻² for 0 to 20 hours;

FIG. 23 shows results of voltage changes over a long period of time (about 260 to 280 hours) under the same conditions;

FIG. 24 shows a process of additionally coating the completed GalinZn surface with Galinstan, unlike the existing GalinZn manufacturing method, to manufacture a new sample named ‘GalinZn #2’;

FIG. 25 is a graph comparing repeated Zn deposition/dissolution behaviors of the Zn electrode (black) and the GalinZn #2 electrode (blue) for initial four hours under the conditions of 0.5 mA cm⁻² and 0.5 mAh cm⁻²;

FIG. 26 is a graph comparing repeated Zn deposition/dissolution behaviors of the Zn electrode (black) and the GalinZn #2 electrode (blue) for 10 hours under the conditions of 0.5 mA cm⁻² and 0.5 mAh cm⁻²;

FIGS. 27 and 28 show results of analyzing a separator surface of a GalinZn device where a short circuit phenomenon occurred using SEM and EDS;

FIG. 29 shows a process of coating the surface of a GalinZn electrode with a polyvinyl alcohol (PVA) solution to manufacture PVA@GalinZn;

FIG. 30 shows a full cell configured to more clearly confirm expected effects of the PVA@GalinZn electrode;

FIG. 31 shows corrosion test results for the Zn (black), GalinZn (blue), and PVA@GalinZn (red) electrodes as Tafel plots;

FIGS. 32 and 33 are graphs comparing repeated Zn deposition/dissolution behaviors appearing when PVA coatings of different thicknesses (2 μm and 10 μm) were applied to the Zn electrode and the GalinZn electrode under the conditions of 0.5 mA cm⁻² and 0.5 mAh cm⁻², FIG. 32 showing voltage changes over a long period of time (up to 3500 hours) and FIG. 33 showing voltage change for initial approximately four hours;

FIGS. 34 and 35 show results of comparing repeated Zn deposition/dissolution behaviors of the Zn electrode (black), PVA (10 μm) @Zn (blue), PVA (10 μm) @GalinZn (green), and PVA (2 μm) @GalinZn (red) under the conditions of 0.5 mA cm⁻² and 0.5 mAh cm⁻² in the short-term (FIG. 34) and long-term (FIG. 35) sections, respectively;

FIG. 36 shows results obtained by observing the Zn deposition/dissolution behaviors up to 15 mA cm⁻² by repeating (step) Zn deposition and dissolution for one hour under the same conditions for the Zn electrode (black) and the PVA@GalinZn electrode (red) and increasing the current density by 0.5 mA cm⁻² in each step;

FIGS. 37 and 38 show results obtained by performing repeated Zn deposition/dissolution tests on the PVA@GalinZn electrode under the conditions of 2 mA cm⁻²/2 mAh cm⁻² and 5 mA cm⁻²/5 mAh cm⁻²;

FIG. 39 shows results obtained by observing a bare Zn sample by in-situ optical spectroscopy;

FIG. 40 shows results obtained by observing Zn deposition patterns over time (0, 20, 40, and 60 minutes) under the current density of 10 mA cm⁻² using the PVA@GalinZn electrode by in-situ optical spectroscopy;

FIG. 41 shows changes in specific capacity according to the number of cycles in a full cell obtained by combining VO₂ (cathode) and Zn or PVA@GalinZn (anode);

FIG. 42 shows voltage-capacity curves from 1st to the 177th charge/discharge of a VO₂//Zn battery; and

FIG. 43 shows voltage-capacity curves from 1st to the 300th charge/discharge of the VO₂//PVA@GalinZn battery.

### DETAILED DESCRIPTION OF THE PREFERRED EMBODIMENTS

Hereinafter, the present invention is described in more detail. However, the present invention may be embodied in various different forms, so the present invention is not limited to the examples described herein, and the present invention is defined only by the claims described below.

In addition, the terms used in the present invention are used only to describe specific examples and are not intended to limit the present invention. The singular expression includes the plural expression unless the context clearly indicates otherwise. Throughout the specification of the present invention, the term “including” a component does not mean to exclude other components but means that to be able to include other components unless specifically stated otherwise.

Throughout the specification, when a part is said to be “coupled (connected, contacted, and joined)” to another part, this includes not only cases of being “directly coupled” but also cases of being “indirectly coupled” with another member interposed therebetween. Also, when a part is said to “include” a component, this does not mean to exclude other components but means that to be able to include other components unless specifically stated otherwise.

In the present application, an “ion-permeable polymer” includes an ion-conductive polymer and means any polymer through which ions can pass through the polymer layer. This is a concept that includes a polymer, even without ion-conductive properties, if the polymer layer is thin or has a porous structure, includes a solvent or electrolyte, or allows ion movement due to ion affinity, plasticity, wettability, interfacial properties, and the like.

Unless otherwise stated, “%” used herein may mean “% by weight” or “wt %” in terms of content.

The terms used in the present application are used only to describe specific examples and are not intended to limit the present invention. The singular expression includes the plural expression unless the context clearly indicates otherwise.

The first aspect of the present invention provides
a secondary battery composite anode, including: a metal layer that includes a first metal; and a liquid metal coating layer that is formed on the metal layer and includes a metal different from the first metal, in which the metal different from the first metal is included in a grain boundary of the first metal.

Hereinafter, the secondary battery composite anode according to the first aspect of the present invention is described in detail.

In one embodiment of the present application, the first metal is limited to a metal used in a secondary battery, and the metal may be selected from at least one of lithium, zinc, sodium, potassium, magnesium, calcium, or aluminum. The first metal may preferably be zinc.

In one embodiment of the present application, the liquid metal coating layer can embody, in various ways, physical and chemical properties (for example, oxidation stability, surface adhesion, and surface tension) in a room temperature or high temperature environment by selectively including two or more different metals. In addition, the bonding ability of the coating layer is improved through the interaction between the metals combined, such as between gallium and indium or between gallium and tin, and the viscosity or fluidity of the liquid phase can be controlled, if necessary. Therefore, more excellent durability or electrical conductivity properties can be expected. Preferably, the metal different from the first metal of the liquid metal coating layer may be at least two selected from the group consisting of gallium (Ga), indium (In), tin (Sn), sodium (Na), lead (Pb), bismuth (Bi), potassium (K), and mercury (Hg). More preferably, the metal different from the first metal of the liquid metal coating layer may be three or more selected from the group consisting of gallium (Ga), indium (In), tin (Sn), sodium (Na), potassium (K), and mercury (Hg).

In one embodiment of the present application, the liquid metal may be, for example, Galinstan, which is a low-melting-point alloy (composite) including gallium (Ga), indium (In), and tin (Sn) as main components and is characterized by maintaining a liquid state even at room temperature. Therefore, by applying the liquid metal, properties such as electrical conductivity, surface adhesion, and the like can be stably secured, and concerns regarding toxic substances or volatile organic solvents are relatively low, allowing for applications in various industrial fields.

In another embodiment of the present application, a protective layer formed on the liquid metal coating layer may be further included. The protective layer additionally formed on the liquid metal coating layer may be designed to stably protect the coating layer from external physical and chemical factors (for example, oxidation, corrosion, and dendrite formation). In particular, such a protective layer may be formed as a separate layer of the liquid metal alone and helps to secure additional mechanical strength or chemical resistance while maintaining the unique fluidity of the liquid metal.

In one embodiment of the present application, the protective layer may be formed with a liquid metal. The liquid metal of the protective layer may be the same as or different from the liquid metal of the liquid metal coating layer. In this case, zinc may be detected on the lower surface of the protective layer (the surface in contact with the liquid metal coating layer) by partial diffusion of zinc, and the protective layer may have a structure in which a concentration gradient in which the molar content or weight content of zinc decreases from the lower surface to the upper surface of the protective layer is formed.

In one embodiment of the present application, the thickness of the protective layer may be 0.015 μm or more, 0.025 μm or more, 0.0375 μm or more, 0.045 μm or more, 0.05 μm or more, or 0.06 μm or more and may be 8.75 μm or less, 7 μm or less, 5.25 μm or less, 5.0 μm or less, 4.375 μm or less, or 3.5 μm or less. If the thickness of the protective layer is excessively thinner than the above-described range, the liquid metal surface may not be sufficiently covered. Therefore, oxidation or corrosion may easily occur, and the risk of damage by mechanical impact or friction may increase. Meanwhile, if the thickness of the protective layer becomes thick to exceed the thickness range, the fluidity of the liquid metal may be hindered, the entire coating structure becomes thicker to make it difficult to embody a microstructure, or the thermal and electrical conductivity characteristics may deteriorate, thereby exhibiting a negative effect in terms of performance.

In still another embodiment of the present application, an outer layer may be further included on the protective layer. That is, a multi-layered structure of protective layer may be applied on the liquid metal coating layer, and this may be to embody longer life characteristics in addition to the characteristics of the composite anode according to one embodiment of the present application in which corrosion characteristics are improved.

In one embodiment of the present application, the thickness of the outer layer may be 0.015 μm or more, 0.025 μm or more, 0.0375 μm or more, 0.045 μm or more, 0.05 μm or more, or 0.06 μm or more and may be 100 μm or less, 50 μm or less, 40 μm or less, 30 μm or less, 20 μm or less, 8.75 μm or less, 7 μm or less, 5.25 μm or less, 5.0 μm or less, 4.375 μm or less, or 3.5 μm or less. If the thickness of the outer layer is excessively thinner than the above-described range, the protective layer or the liquid metal coating layer may not be sufficiently covered. Therefore, a short circuit may be easily caused, and the risk of damage by mechanical impact or friction may increase. Meanwhile, if the thickness thereof becomes thick to exceed the thickness range, the fluidity of the liquid metal may be hindered, the entire coating structure becomes thicker to make it difficult to embody a microstructure, or the thermal and electrical conductivity characteristics may deteriorate, thereby exhibiting a negative effect in terms of performance.

In one embodiment of the present application, the outer layer may be formed with the ion-permeable polymer. The ion-permeable polymer has excellent physical flexibility and is easy to be applied in various coating methods. The outer layer formed with such an ion-permeable polymer protects both the inner liquid metal coating layer and the protective layer on the coating layer and prevents leaking of the liquid metal of the liquid metal coating layer, thereby performing a key function in various application fields such as devices and sensors.

In one embodiment of the present application, the ion-permeable polymer may include, in addition to a known polymers such as at least one selected from polyvinyl alcohol (PVA), polyacrylamide (PAM), poly(styrene sulfonate) (PSS), polyethylene oxide (PEO), polyacrylic acid-based gel (Carbopol), polydopamine (PDA), polyaniline (PANI), polyimide (PI), polypyrrole (PPy), polyvinylidene fluoride (PVDF), polyvinylidene fluoride-hexafluoropropylene (PVDF-HFP), polyethylene glycol (PEG), polyvinylpyrrolidone (PVP), poly(2-hydroxyethyl methacrylate) (PHEMA), polyacrylic acid (PAA), carboxymethyl cellulose (CMC), polytetrafluoroethylene (PTFE), polymethyl methacrylate (PMMA), polyethyleneimine (PEI), chitosan, poly(2-acrylamido-2-methylpropanesulfonic acid) (PAMPS), sodium alginate, polystyrene (PS), polypropylene (PP), polycarbonate (PC), and polycaprolactam (PA6), a material composited by being mixed with a conductive additive such as metal nanoparticles or carbon nanotubes (CNT). Through this, the conductive characteristics, mechanical strength, heat resistance, light transmittance, or the like can be adjusted as needed, thereby providing high applicability in various application fields.

In one embodiment of the present application, the composite anode can penetrate the entire surface or metal layer, and in particular, may be composited in a form that includes a metal different from the first metal in the grain boundary of the first metal. For example, according to the present invention, by embodying a structure in which a metal different from the first metal penetrates and disperses in the grain boundary region of a metal layer formed with the first metal (for example, zinc), the stability of the interface between the grains can be increased and durability (especially, corrosion stability) can be improved. Typically, corrosion tends to start around the grain, but according to one embodiment of the present application, a liquid metal that is not easily corroded penetrates into the grain, whereby the effect in which corrosion is prevented can be confirmed. Also, in this structure, through chemical and physical interaction, the metal different from the first metal is densely arranged in the grain boundary or forms a composite state, so that important performances as a secondary battery anode such as electrical conductivity and ion transfer characteristics can be improved. More specifically, since the grain boundary of the first metal not only exists on the surface of the metal layer but also greatly affects the internal microstructure, the occurrence of microcracks, corrosion, or the like can be suppressed by causing other metals to be included in this grain boundary. In addition, as the metal-based composite structure is formed, it is possible to flexibly deal with volume expansion that occurs during an electrochemical reaction. Therefore, the structural stability is increased during the charge/discharge process, and ultimately an effect of improving the lifespan and output characteristics of the secondary battery can be expected.

In one embodiment of the present application, in the liquid metal coating layer, the first metal and a metal different from the first metal may exist, and in the protective layer, combinations of metal different from the first metal may exist, or a trace amount of the first metal may exist in a diffused state. That is, in this case, a structure in which a first metal element as a parent and elements derived from a liquid metal different from the first metal exist together on the surface of the anode may be possible.

In another embodiment of the present application, when the protective layer exists on the liquid metal coating layer, the protective layer may have a structure in which the first metal element as the parent does not exist, and only the additionally coated liquid metal (element(s) different from the first metal) exists.

In still another embodiment of the present application, when a protective layer exists on the liquid metal coating layer, and an outer layer exists on the protective layer, the outer layer may have a structure in which a separate layer is formed with a polymer, may have a one-layer form in which the components of the outer layer and the protective layer are mixed, and may also have a laminated structure in which only some areas are mixed with each other.

In still another embodiment of the present application, the thickness of the byproduct layer formed at a topmost portion formed after the secondary battery composite anode is immersed in an electrolyte for 10 days may be less than 7 μm on average and preferably less than 5 μm. In particular, especially when immersed in an aqueous electrolyte, considering that a byproduct layer may be formed due to corrosion exceeding 10 μm in the case of a zinc metal anode, this structure can appear only in the present invention.

A second aspect of the present application provides:
a method for manufacturing a secondary battery composite anode including: a step of coating the metal layer with a liquid metal including a metal different from the first metal; a step of scraping the coated liquid metal; and a step of wiping a surface of the scraped metal layer to form a liquid metal coating layer.

Detailed description of portions overlapping with those in the first aspect of the present application is omitted, but contents described for the first aspect of the present application can be equally applied, even if the description is omitted in the second aspect.

Hereinafter, a method for manufacturing a secondary battery composite anode according to the second aspect of the present invention is described in detail.

First, in one embodiment of the present invention, the step of coating the metal layer with a liquid metal including a metal different from the first metal can be included. For example, a process of coating the metal layer with the liquid metal may include various methods without limitation, for example, relatively simple equipment such as spin-coating, dip-coating, printing, and spraying processes, and more precise solution processes and deposition processes. This process can be performed in a temperature range from room temperature to 300° C. or higher, and the coating time can also be selected from several seconds to several tens of hours. Therefore, the process can be flexibly controlled according to the viscosity, thickness, and type of solvent of the liquid metal. In addition, oxidation of the metal or contamination can be reduced by performing the process in a vacuum or inert gas atmosphere (for example, nitrogen and argon), and it is possible to increase the interfacial bonding strength between the coating layer and the metal layer and secure stability by adding a heat treatment (annealing) or a subsequent cleaning process, if necessary.

Next, in one embodiment of the present invention, the step of scraping the coated liquid metal can be included. For example, the scraping process can be performed in various temperature ranges from room temperature to hundreds of degrees (° C.), and the time can also be flexibly set from several seconds to several tens of minutes depending on the physical properties of the liquid metal (for example, viscosity and solidification temperature). A wide range of methods from a manual method (for example, scraping with a spatula or brush) to a method using automated equipment such as a doctor blade or a roll coater can be applied. In addition, oxidation or contamination can be suppressed by performing scraping in an inert gas atmosphere (nitrogen, argon, and the like), and the liquid metal can be diffused and removed to a uniform thickness by controlling the scraping angle and pressure, thereby helping to obtain the desired coating quality.

Next, in one embodiment of the present application, the step of wiping the surface of the scraped metal layer to form the liquid metal coating layer can be included. For example, the surface on the metal layer that has undergone the scraping process can be wiped for a certain period of time (several seconds to several minutes) with nonwoven fabric, sterile gauze, roller-type wiper, or the like to uniformly disperse and remove the liquid metal, thereby forming a final coating layer. In general, this process can be performed at room temperature, and the strength or number of times of the wiping can be differently adjusted depending on the viscosity and thickness of the liquid metal. If necessary, the surface cleaning process can be performed at the same time with a solvent such as deionized water, ethanol, or isopropanol, and then the coating layer can be stabilized by being dried for several minutes to several tens of minutes under room temperature and pressure conditions. In addition, the equipment, temperature, and time conditions can vary depending on the characteristics of the metal substrate and the liquid metal.

Next, in an additional embodiment of the present application, a step of wiping the surface of the scraped metal layer to form a liquid metal layer; and then a step of forming a protective layer on the liquid metal coating layer can be further included. Matters related to the physical properties of the protective layer are described above and thus are omitted. For example, after the liquid metal layer formed on the scraped metal layer is stabilized, a protective layer can be formed by additionally applying a separate liquid metal. Here, spin coating, dip coating, a spray process, or a coating method using a doctor blade or a roll coater may be freely applied. The process time may be flexibly adjusted from several seconds to several tens of minutes depending on the target characteristics such as the viscosity of the liquid metal and the coating thickness, and the working temperature may also be set within a range from room temperature to several hundred degrees (° C.). In addition, an inert gas atmosphere such as nitrogen (N₂) or argon (Ar) or a vacuum environment can be utilized in order to minimize oxidation of the liquid metal or contamination during the process, and the interface bonding strength and coating uniformity can be improved by performing a heat treatment (annealing) or a solvent evaporation process after coating, if necessary.

Next, in another additional embodiment of the present application, a step of forming a protective layer on the liquid metal coating layer; and then a step of forming an outer layer formed with an ion-permeable polymer on the protective layer can be further included. For example, when the protective layer is thinly coated with an ion-permeable polymer (for example, a PVA solution, such as a solution in which 10 g of PVA is dissolved in 20 ml of water) after the process of the protective layer (liquid metal) additionally formed on the liquid metal coating layer, the applicator is set to 2 to 150 um higher than the zinc foil thickness by using commercially available bar coating equipment or spray equipment, and the ion-permeable polymer is applied and dried at room temperature for 0.1 to 5 hours, whereby a polymer thin film having a thickness of 2 to less than 10 um can be obtained. If necessary, the process can be carried out in an atmosphere of inert gas such as nitrogen (N₂) or argon (Ar) or in a vacuum to suppress oxidation or contamination, and the solution viscosity, the coating speed, the drying temperature (for example, room temperature to 100° C.), and the like can be adjusted in detail according to the target thickness and uniformity, whereby the process can be applied to various fields of application.

A third aspect of the present application provides
a secondary battery including a cathode; the anode; and an electrolyte.

Detailed description of portions overlapping with those in the first aspect and the second aspect of the present application is omitted, but contents described for the first aspect and the second aspect of the present application can be equally applied, even if the description is omitted in the third aspect.

Hereinafter, the secondary battery according to the third aspect of the present application is described in detail.

In one embodiment of the present application, the zinc secondary battery has a structure capable of electrochemical charging and discharging, and various materials can be applied as the cathode active material. Representative examples thereof include metal oxides or metal complex compounds including vanadium oxide (VO₂, V₂O₅), manganese oxide (MnO₂), nickel oxide (NiOₓ), prussian blue analogues of copper hexacyanoferrate (CuHCF) series, and the like. In addition, carbon-based conductive materials (carbon black, acetylene black, and the like) may be mixed in an appropriate ratio to further increase electron transfer properties within the cathode. The form of the cathode active material can be embodied in various ways such as powder, thin film, and nanostructure forms, and this selection varies depending on device characteristics or manufacturing processes.

In one embodiment of the present application, the separator refers to a material that is selected to physically block contact between the cathode and the anode but allows ions to freely move. Representative porous membranes of polyolefin series such as polypropylene (PP) and polyethylene (PE) can be used, and paper of cellulose series or glass fiber separators are also considered. The separator must maintain chemical stability when in contact with the electrolyte, and at the same time, must have uniform pores (cavities) so as not to hinder ion conductivity. Additionally, in some embodiments, an inorganic particle coating (for example, alumina or zirconia) may be introduced to improve heat resistance and chemical resistance.

In one embodiment of the present application, the electrolyte provides an ion movement path for the zinc secondary battery and can be mainly classified into an aqueous or non-aqueous type. As an aqueous electrolyte, potassium hydroxide (KOH), zinc sulfate (ZnSO₄) solution, an aqueous solution of Zn(OTf)₂, and salts of acetate or phosphate series can be mixed at an appropriate concentration and used. In the case of a non-aqueous electrolyte, a form in which an organic solvent (for example, a carbonate series) and zinc salt (for example, Zn(CF₃SO₃)₂) are mixed is possible, but an aqueous electrolyte is generally used more in terms of stability and ease of manufacture. In addition, recently, technologies using gel-type electrolytes (polyvinyl alcohol (PVA)-based gel or the like) or solid electrolytes (such as ceramic materials or the like) have been studied and can be applied differently depending on the installation environments or special purposes.

In one embodiment of the present application, the current collector plays a role in supporting even exchange of currents between cathode and anode materials. Titanium (Ti), nickel (Ni), stainless steel (including special alloys), and the like which have good corrosion resistance and good electrical conductivity can be considered as the cathode current collector in the zinc secondary battery. In addition, carbon-based materials (carbon cloth, carbon paper, carbon nanotubes, and the like) can also be utilized. The cathode current collectors described above can be used on the anode side, and preferably a zinc plate or a zinc-plated metal foil can be directly utilized, and copper (Cu)-based materials can also be used as an additional support. Since the current collector should not cause corrosion or oxidation problems even during long-term charging and discharging, a metal surface treatment or protective coating (for example, Ni plating or carbon coating) may be also applied.

In one embodiment of the present application, a conductive additive is an additive used to improve electrical connection within the electrode. Generally, materials such as carbon black, acetylene black, graphite powder, carbon nanotubes (CNT), or graphene are used. These materials have high electron conductivity to help electrode active materials to evenly transfer electrons, and, at the same time, maintain mechanical flexibility of the electrode in some degree. In addition, a resistance value within the electrode greatly varies depending on the concentration or dispersion method of the conductive additive, and thus it is important to evenly disperse the conductive additive by applying an appropriate composition and a pretreatment process.

In one embodiment of the present application, the binder binds the electrode active material and the conductive additive to maintain the electrode structure and plays a role of alleviating volume changes that may occur during charging and discharging. Representatively, polyvinylidene fluoride (PVDF), polytetrafluoroethylene (PTFE), carboxymethyl cellulose (CMC), styrene-butadiene rubber (SBR), and the like are used. Since the binder affects chemical stability with the electrolyte, adhesion, cavity control within the electrode, and the like, the type and mixing ratio are set differently depending on the required cell performance. In addition, when manufacturing is performed through an aqueous process, an aqueous binder such as CMC or SBR may be advantageous, and a PVDF series is widely used in an organic solvent-based process.

In one embodiment of the present application, the zinc secondary battery manufactured by appropriately combining such components has low toxicity and high stability and thus can be applied to various energy storage device fields. For example, the zinc secondary battery is widely considered in large-scale energy storage systems (ESS), portable electronic devices, military power sources, and the like. In addition, zinc is relatively abundant on the Earth and price competitive, and thus has great marketability as an alternative secondary battery technology. In the future, nanostructure technologies and surface treatment processes for improving energy and power densities, as well as cycle life, are expected to be more importantly studied.

Hereinafter, examples of the present invention will be described in detail so that a person having ordinary skill in the art to which the present invention pertains can easily practice. However, the present invention can be embodied in various different forms and is not limited to the examples described herein.

### Preparation Example 0: Preparing Liquid Metal

After 68.5 wt % of gallium (Ga), 21.5 wt % of indium (In), and 10 wt % of tin (Sn) were weighed and introduced into a vial, a heat treatment was performed in a glove box in an argon atmosphere to prevent the formation of oxide films of gallium, indium, and tin. The heat treatment was performed using a hot plate, and Galinstan liquid metal was prepared by heating at 300 degrees for one hour or longer. After that, in all preparation examples and examples utilizing the liquid metal, the liquid metal was used after it was confirmed to maintain a liquid state at room temperature.

### Preparation Example 1-1: Preparing of Zinc Secondary Battery Composite Anode

13 μL of Galinstan prepared in Preparation Example 0 was dropped evenly on a zinc foil and then was brought into contact for about 90 seconds, and the liquid metal remaining on the surface was removed by scraping. Thereafter, the surface was washed with ethanol and dried at room temperature and pressure for about 30 minutes to prepare a GalinZn composite.

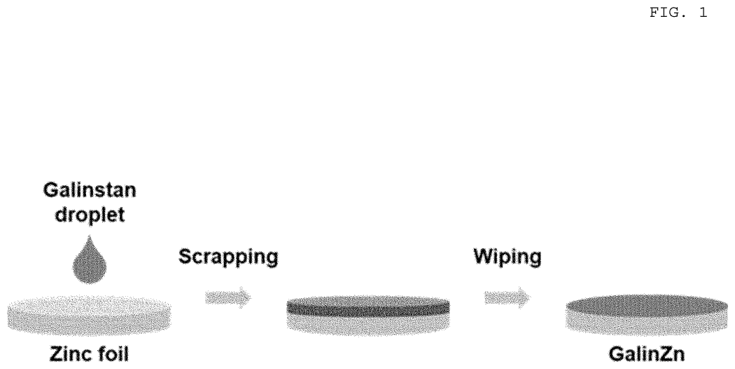

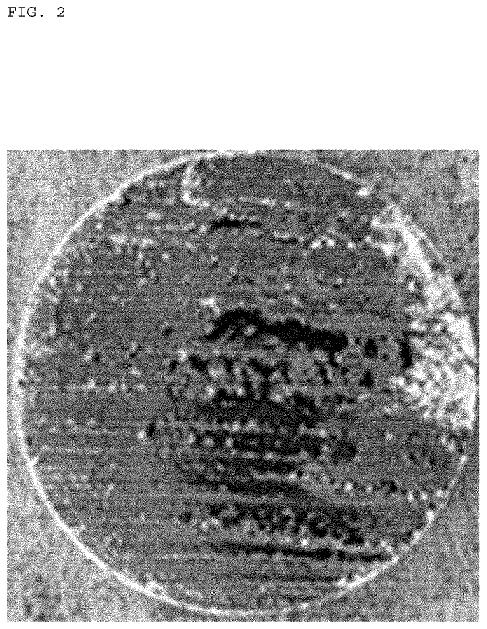

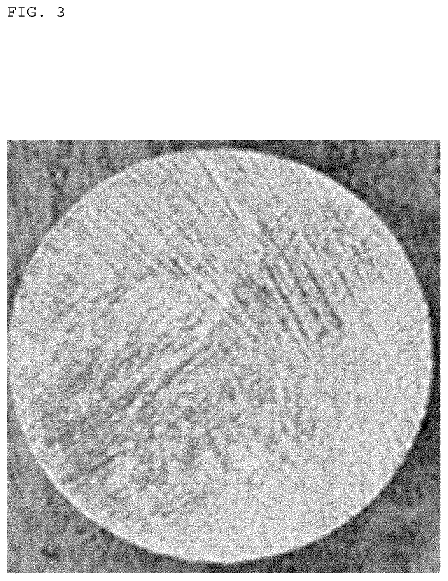

FIG. 1 is a schematic diagram showing a method for manufacturing a composite anode material according to one embodiment of the present invention. FIG. 2 is a photograph showing a surface of a composite anode after scraping according to the method for manufacturing a composite anode material according to one embodiment of the present invention. FIG. 3 is a photograph showing a surface of a composite anode after wiping according to the method for manufacturing a composite anode material according to one embodiment of the present invention.

Referring to FIG. 2, a state in which a zinc foil is coated with a certain amount (about 13 μL) of Galinstan is shown, and in the scrapped image below, the appearance of a sample of which the surface was scrapped to partially remove Galinstan and then was washed with ethanol can be confirmed. FIG. 3 shows the GalinZn composite finally obtained after washing and drying, in which the Galinstan appears to have partially reacted with the zinc surface during the scraping process, resulting in an evenly dispersed composite was formed.

### Comparative Example 1-1: SEM and EDS Analysis of Surface of Composite Anode

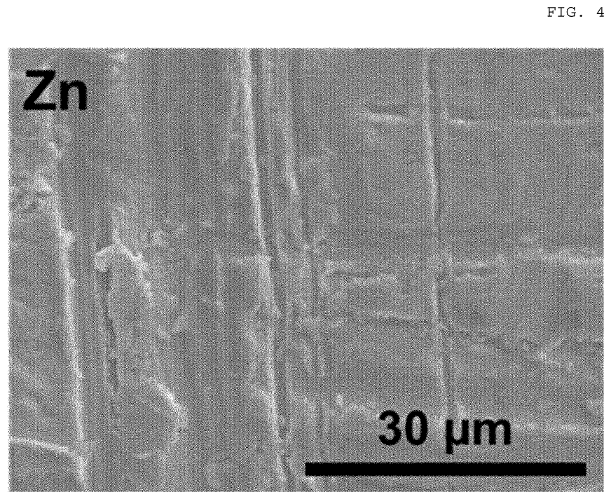

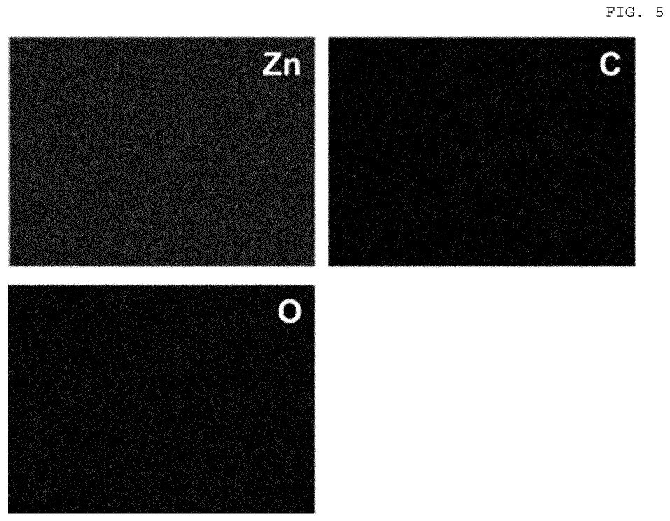

FIG. 4 shows an SEM image of a surface of a zinc anode material of a Comparative Example, and FIG. 5 shows an EDS analysis image of the surface of the zinc anode material of the Comparative Example.

Referring to FIGS. 4 and 5, as a result of confirming the Zn surface, it was found that scratches occurred on the surface due to polishing, and in the EDS analysis, almost no oxygen components other than Zn were detected, confirming that Zn oxide was effectively removed. According to the EDS analysis, Zn was mainly detected, and trace amounts of C and O were detected.

### Comparative Example 1-2: SEM and EDS Analysis of Cross-Section of Composite Anode

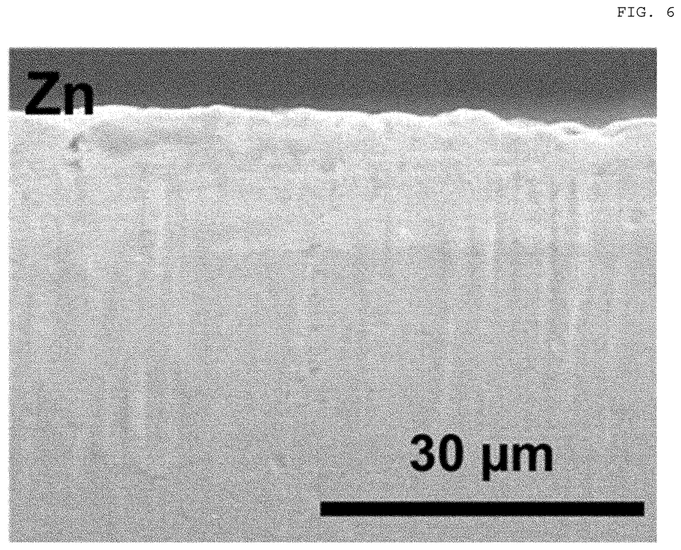

FIG. 6 shows an SEM image of a cross-section of the zinc anode material of the Comparative Example, and FIG. 7 shows an EDS analysis image of the cross-section of the zinc anode material of the Comparative Example.

As a result of the measurement, it was confirmed that the Zn component was uniformly distributed throughout the cross-section, and trace amounts of oxygen and carbon components were detected, thereby proving that the oxide layer was effectively removed.

### Example 1-1: SEM and EDS Analysis of Surface of Composite Anode

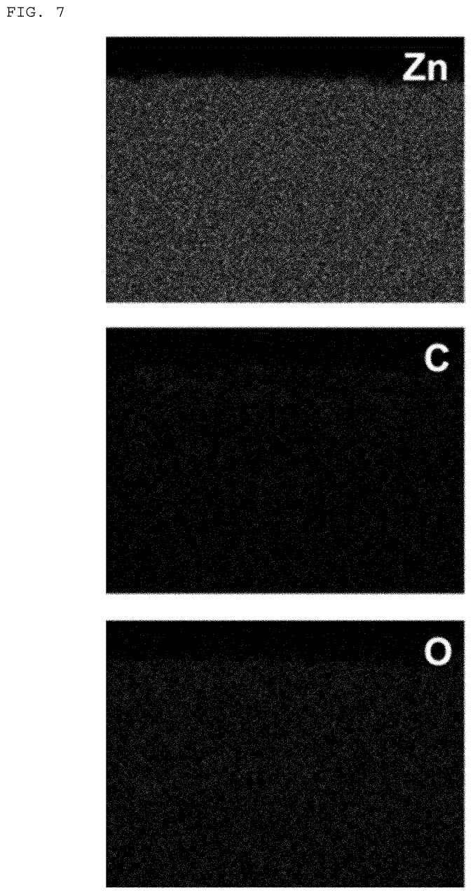

FIG. 8 shows an SEM image and an EDS analysis image of the surface of the zinc composite anode material according to one embodiment of the present invention.

As a result of the observation, it was confirmed that Ga, In, and Sn coexisted between Zn grain boundaries, and the distribution of each element was clearly revealed in the EDS mapping.

As a result of analyzing the GalinZn surface with the SEM and the EDS, it was confirmed that Ga, In, and Sn coexisted along the Zn grain boundaries in the composite, meaning that the bonding between metal was uniform according to the microstructural characteristics of the composite.

### Example 1-2: SEM Analysis of Cross-Section of Composite Anode

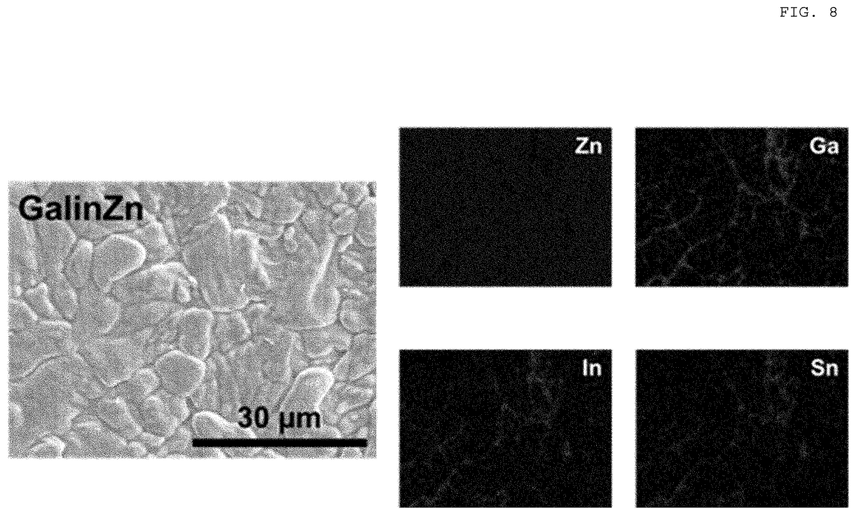

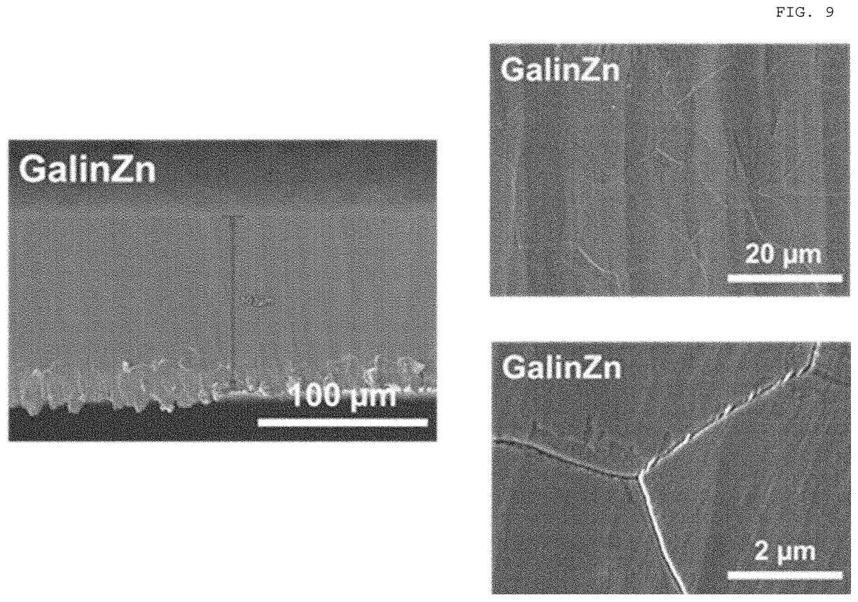

FIG. 9 shows an SEM image of the cross-section of the zinc composite anode material according to one embodiment of the present invention.

As a result of observation of the GalinZn cross-section, it was confirmed that Ga, In, and Sn coexisted between Zn grain boundaries, and the measured thickness of the cross-section was approximately 103 μm. From this, it can be inferred that a uniform bond was formed between metal within the composite. Since the grain boundaries were clearly identified in the microstructure, it can be understood that GalinZn was formed with a stable structure.

### Example 1-3: EDS Analysis of Cross-Section of Composite Anode

FIG. 10 shows an SEM image and an EDS analysis image of the cross-section of the zinc composite anode material according to one embodiment of the present invention. As a result of observation of the GalinZn cross-section, it was confirmed that Ga, In, and Sn coexisted between Zn grain boundaries, and the measured weight percentages of the elements were 87.50 wt % of Zn, 9.50 wt % of Ga, 1.99 wt % of In, and 1.00 wt % of Sn. In addition, compared to Galinstan (Ga:In:Sn=68.5:21.5:10), it can be understood that Zn is the main component in the present composite, and Ga, In, and Sn are dispersed in an appropriate ratio.

The results analyzed with the EDS are as follows.

Map Sum Spectrum

| Element | Signal Type | Line | Wt % | Wt % Sigma | Atomic % |
|---|---|---|---|---|---|
| Zn | EDS | L series | 87.50 | 0.18 | 89.20 |
| Ga | EDS | L series | 9.50 | 0.13 | 9.08 |
| In | EDS | L series | 1.99 | 0.10 | 1.16 |
| Sn | EDS | L series | 1.00 | 0.11 | 0.56 |
| Total | | | 100.00 | | 100.00 |

Through this, it can be confirmed that interfacial bonding between the constituent metals is uniformly formed within the GalinZn composite, and it is considered that the microstructure of the composite is stably maintained by introducing Ga, In, and Sn into the Zn grain boundaries.

### Comparative Example 1-3 and Example 1-4: XPS Analysis of Surface of Composite Anode

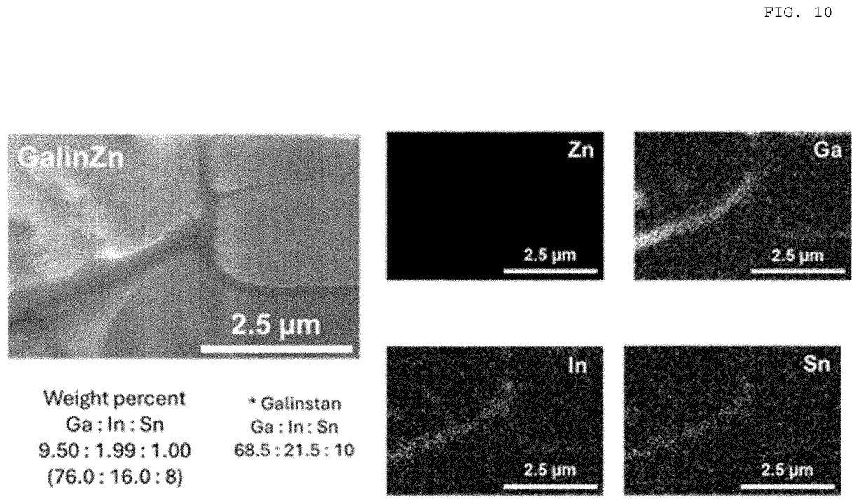

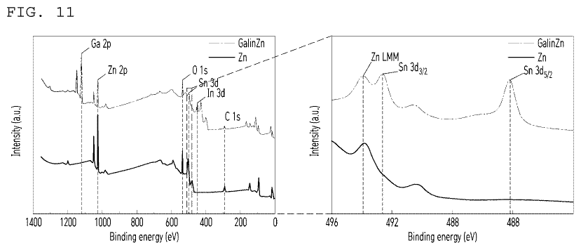

FIG. 11 shows an XPS spectrum of the surface of the zinc composite anode material according to one embodiment of the present invention. It can be understood that only peaks for Zn, C, and O were confirmed in the case of the Zn sample, while peaks for Ga, In, and Sn were additionally detected in the GalinZn sample.

From this, it can be confirmed that Ga, In, and Sn are composited and coexist on the Zn surface in the GalinZn composite, and the characteristics of the composite including various metal elements compared to Zn are clearly revealed in the XPS spectrum.

### Comparative Example 1-4: Analysis of Corrosion Characteristics of Zinc Anode

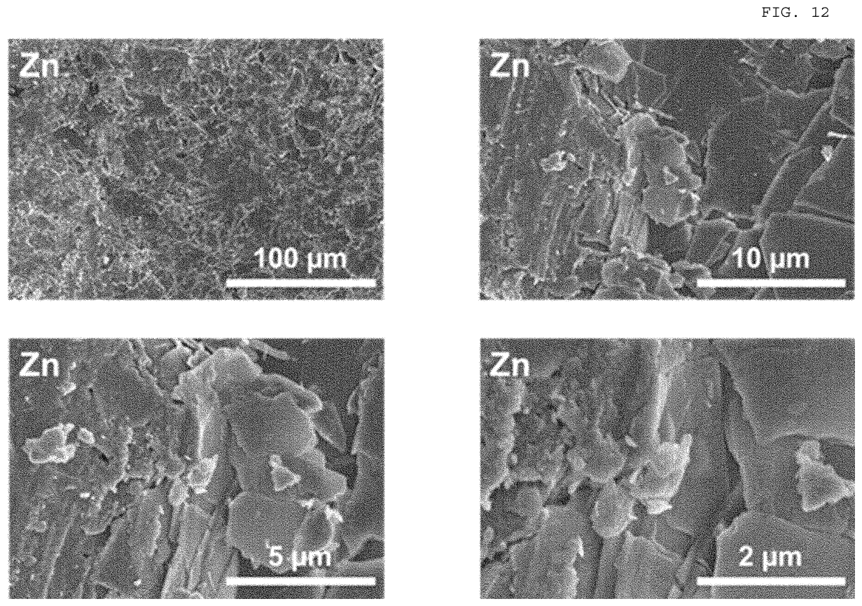

FIG. 12 shows an SEM image obtained by examining corrosion characteristics of the surface of the zinc anode material of the comparative example. As a result of the observation, it can be confirmed that byproducts were formed on the bare Zn surface after immersion in the electrolyte, and the structure in which the byproducts were distributed in the form of flakes clearly appeared at each magnification (500×, 5000×, 10000×, and 20000×).

From this, it can be seen that, when bare Zn is immersed in the electrolyte for a long period of time, the surface thereof is damaged by corrosion reaction, and byproducts are generated in the course. This suggests that the corrosion resistance of the Zn metal itself is limited, and it can be confirmed that it is difficult to maintain the stability of Zn when Zn is immersed for a long period of time.

FIG. 13 shows an SEM image and an EDS analysis image obtained by examining corrosion characteristics of the surface of the zinc anode material of the Comparative Example. It can be confirmed that the byproducts were formed in a form in which Zn, C, O, F, and S are mixed and were distributed in a layered or flake form over the entire surface. This suggests that, when bare Zn is immersed in the electrolyte for a long period of time, the Zn surface is damaged by corrosion reaction, Zn is combined with various ions to generate byproducts, and these byproducts can cause additional defects in the Zn metal structure.

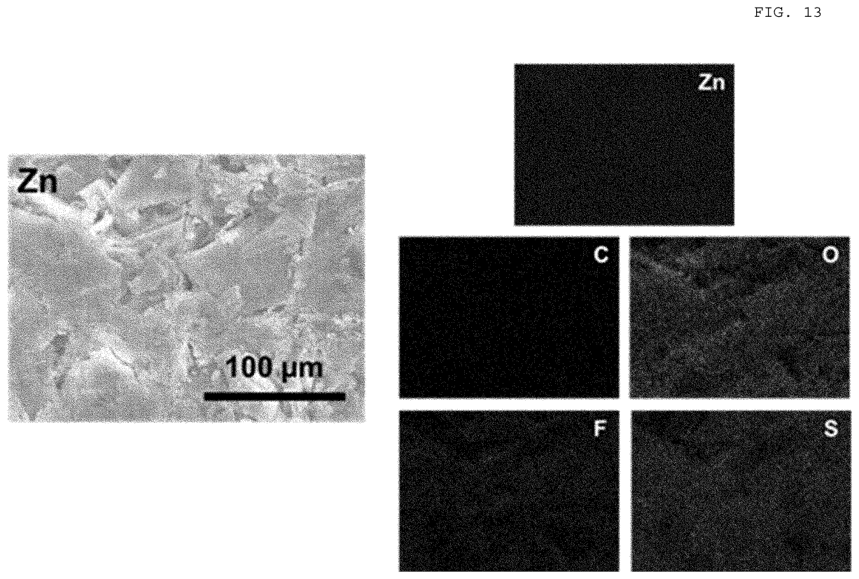

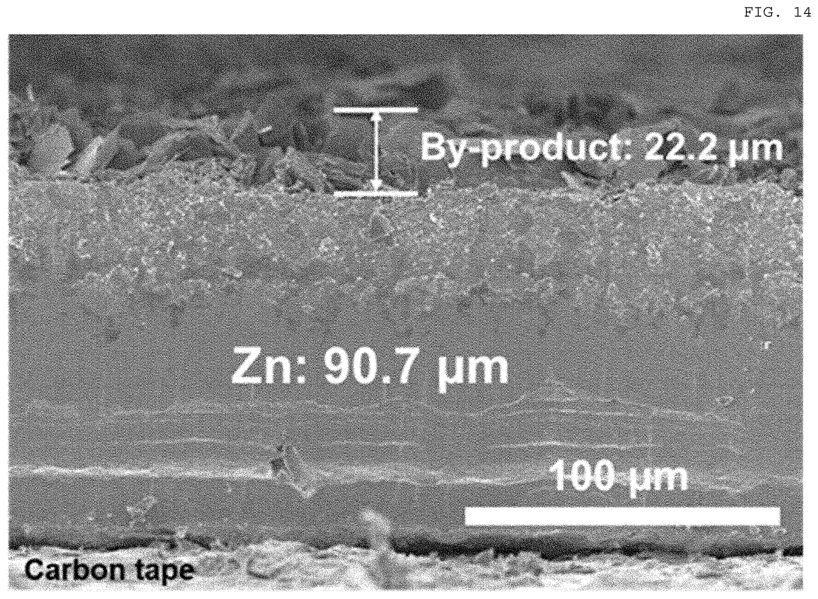

FIG. 14 shows an SEM image obtained by examining the corrosion characteristics of the cross-section of the zinc anode material of the comparative example. It was confirmed that, after immersion in the electrolyte, byproducts with a thickness of about 22 μm were formed on the Zn surface, and the Zn itself maintained a thickness of about 90.7 μm.

### Example 1-5: Analysis of Corrosion Characteristics of Zinc Composite Anode

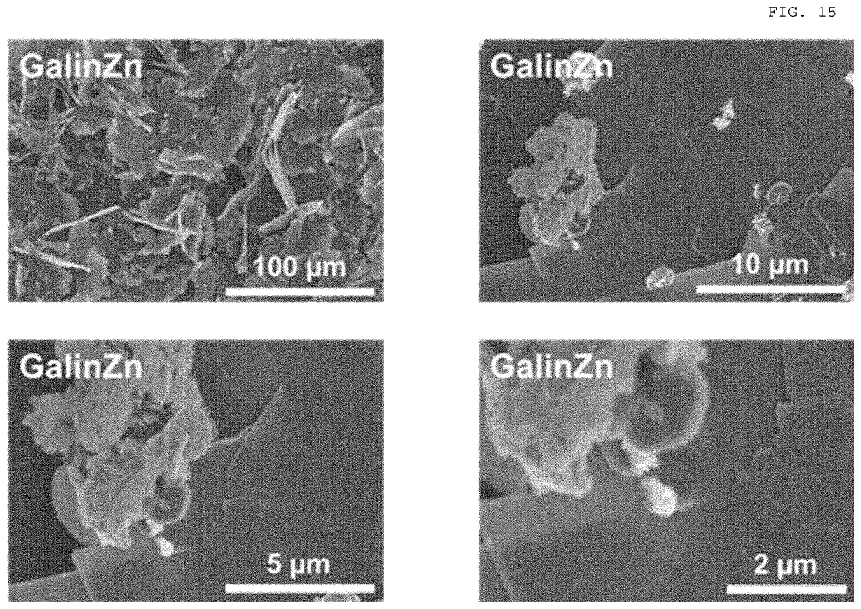

FIG. 15 shows an SEM image obtained by examining the corrosion characteristics of the surface of the zinc anode material of the zinc composite anode material according to one embodiment of the present invention.

In the case of GalinZn, byproducts are also formed after immersion in the electrolyte but are formed noticeably less than in the case of bare Zn, and from this, it can be inferred that the GalinZn composite has excellent corrosion resistance in an electrolyte environment.

Therefore, it is considered that GalinZn exerts a surface protection effect during electrolyte immersion due to the complexation among Zn, Ga, In, and Sn, and this is thought to be a result of the difference in microstructure affecting the actual corrosion behavior.

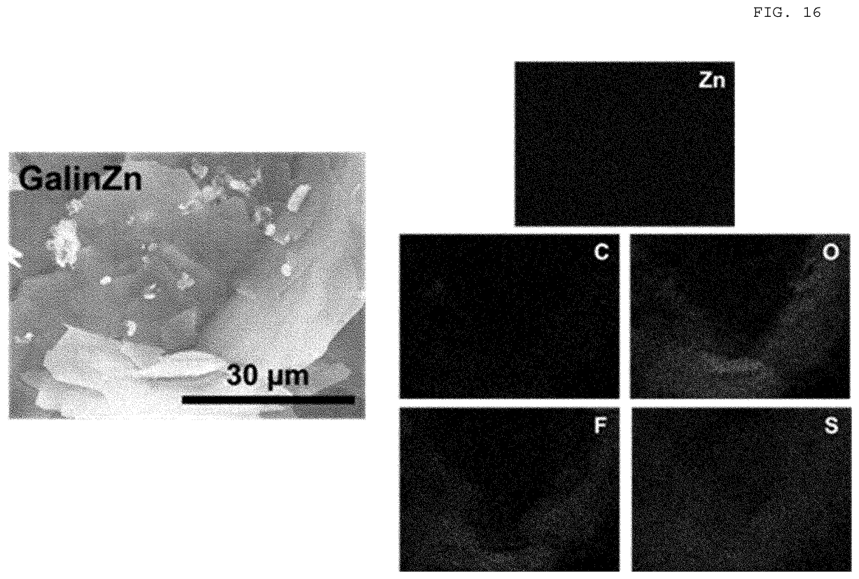

FIG. 16 shows an SEM image and an EDS analysis image obtained by examining the corrosion characteristics of the surface of the zinc anode material of the zinc composite anode material according to one embodiment of the present invention. It can be confirmed that byproducts in a form in which Zn, C, O, F, and S are mixed were formed, similar to bare Zn, but relatively less byproduct formation was observed in the case of the GalinZn composite. From this, it can be inferred that the GalinZn composite has excellent corrosion resistance in the electrolyte compared to Zn, and this is thought to be because the surface stabilization effect caused by the compositeness suppressing the corrosion reaction.

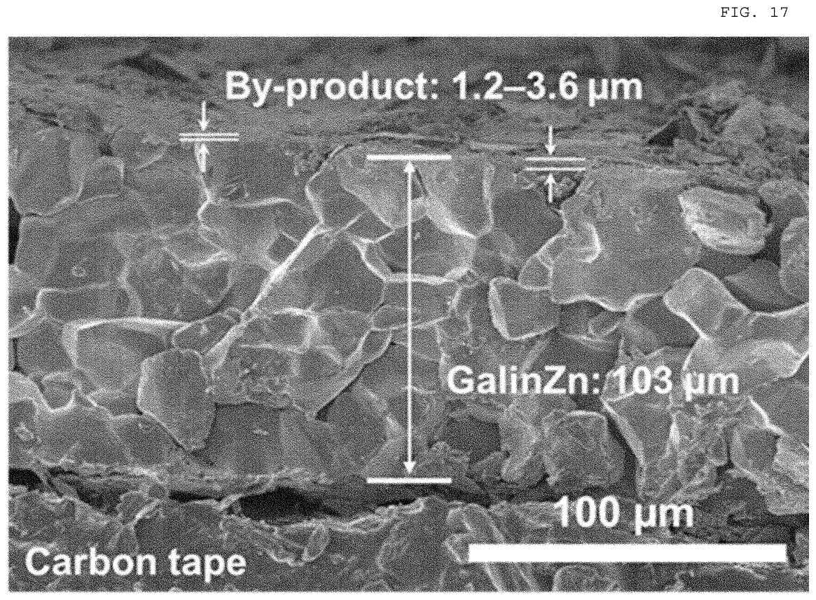

FIG. 17 shows an SEM image obtained by examining the corrosion characteristics of the cross-section of the zinc anode material of the zinc composite anode material according to one embodiment of the present invention. As confirmed, a byproduct with a thickness of about 22 μm was formed in the case of bare Zn, but relatively thin byproducts of about 1 to 4 μm were formed in the case of GalinZn, and thus it is understood that the corrosion resistance is improved. This is because OH-generated in the hydrogen evolution reaction (HER) that occurs with the corrosion reaction is involved in the formation of byproducts, and less generation of byproducts means that corrosion occurred relatively less. Therefore, it can be determined that the corrosion resistance of GalinZn is superior to that of bare Zn.

### Comparative Example 1-5 and Example 1-6: Analysis of Anode Corrosion Characteristics (Tafel Plot)

FIG. 18 shows a Tafel plot of the zinc composite anode material according to the Comparative Example and one embodiment of the present invention.

In the case of GalinZn, a corrosion voltage (E_corr) is increased to about −1.14 V, and a corrosion current (I_corr) is about 6.4 μA, so it is confirmed that the corrosion current is reduced by more than 20 times compared to Zn. This means that the corrosion resistance of Zn is greatly improved owing to the compositing of GalinZn, and it is expected that the performance degradation due to corrosion will be significantly reduced when used for a long period of time in an actual electrode environment.

### Preparation Example 1-2: Symmetric Battery Configuration

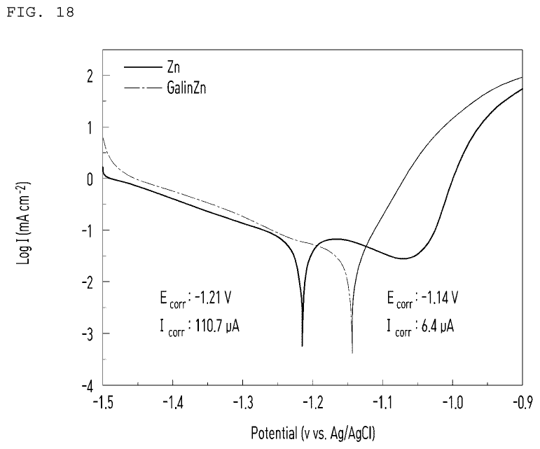

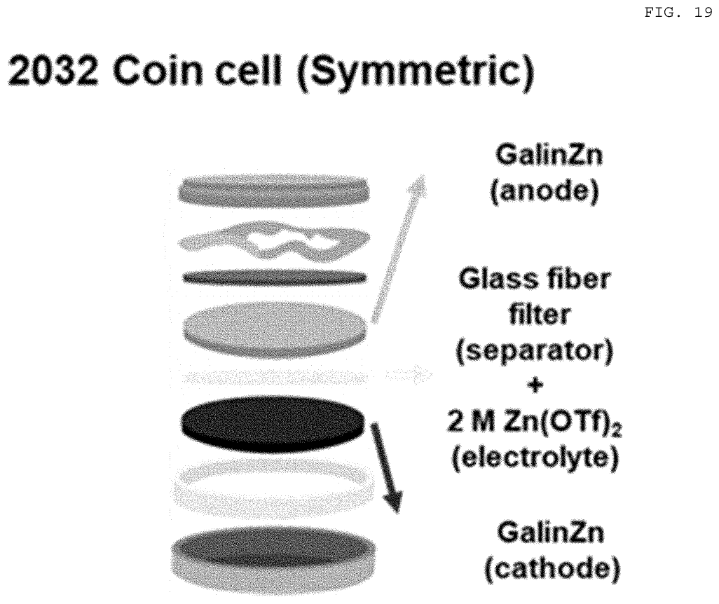

FIG. 19 shows a symmetric battery configured in the form of a 2032 coin cell. In order to confirm the long life characteristics of the electrode by performing repeated Zn deposition and dissolution reactions, GalinZn electrodes were used for both the cathode and the anode, a glass fiber filter (GF/B, Whatman) was applied as a separator, and 2 M Zn(OTf)₂ was applied as an electrolyte.

Through this, it is possible to evaluate whether the GalinZn electrode shows stable Zn reaction behaviors in a symmetrical structure, and it can be demonstrated that excellent corrosion resistance can be maintained even during charge and discharge for a long period of time.

### Experimental Example 1-1: Evaluation of Zinc Secondary Battery Anode Performance

FIG. 20 shows results of evaluating the repeated Zn deposition/dissolution behavior of a Zn electrode and a GalinZn electrode under conditions of 0.5 mA cm⁻² and 0.5 mAh cm⁻². While the bare Zn electrode failed with a large voltage spike after about 74 hours, the GalinZn electrode maintained a stable deposition/dissolution process for about 273 hours, and it can be confirmed that the overpotential and voltage spike due to Zn nucleation were significantly reduced after the first cycle.

Through this, it can be confirmed that the GalinZn electrode secures long life characteristics and low overpotential compared to Zn. This may be because Galinstan coating facilitates surface corrosion prevention and crystal nucleation and enables uniform Zn deposition, to improve stability during repeated charge/discharge, thus improving stability during repeated charge/discharge.

FIG. 21 shows voltage changes of anodes of one embodiment and Comparative Example of the present invention for initial approximately four hours, respectively. Referring to FIG. 21, while the Zn electrode started deposition at about −119 mV, the GalinZn electrode was deposited at a more negative potential of about −215 mV, and thus it is understood that the overpotential is increased due to initial nucleation. However, after the first cycle, it can be seen that the overpotential and voltage increase phenomenon for nucleation of the GalinZn electrode are significantly reduced compared to those of the Zn electrode. That is, it is considered that surface corrosion is prevented and nucleation is facilitated by the GalinZn coating, allowing for uniform Zn deposition, thus the electrode surface is stabilized to secure long-life characteristics, and voltage fluctuations are alleviated even during repeated charge/discharge, and therefore stability is improved.

FIG. 22 shows results obtained by observing the repeated Zn deposition/dissolution behavior of a Zn electrode (black) and a GalinZn electrode (red) under conditions of 0.5 mA cm⁻² and 0.5 mAh cm⁻² for 0 to 20 hours. Except for the first cycle, it can be confirmed that the voltage spike and overpotential due to Zn nucleation are significantly reduced for GalinZn.

FIG. 23 shows voltage changes over a long period of time (about 260 to 280 hours) under the same conditions, and deposition/dissolution was stably performed for about 273 hours for the GalinZn electrode, unlike for the bare Zn. That is, it can be understood that the electrode surface is stabilized through the GalinZn coating to secure long life characteristics, and at the same time, the overpotential increase is suppressed during repeated charge and discharge.

### Preparation Example 2-1: Manufacturing of Zinc Secondary Battery Composite Anode

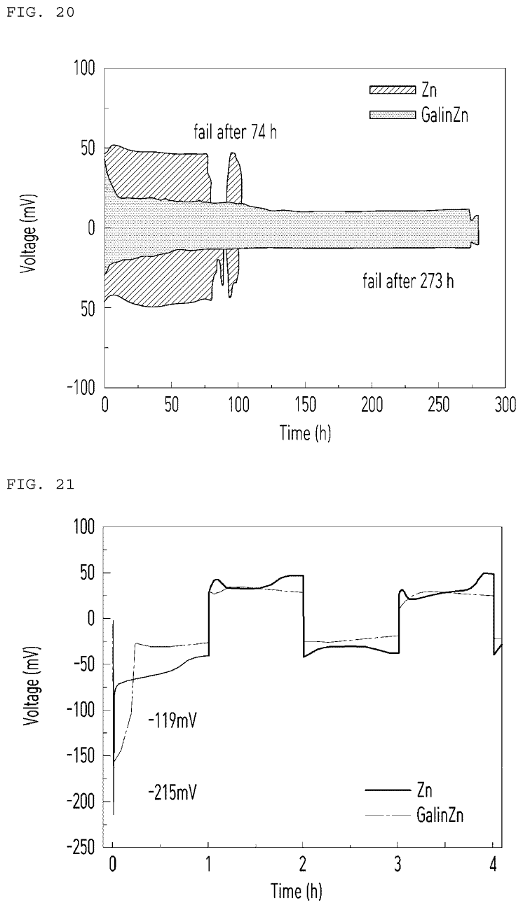

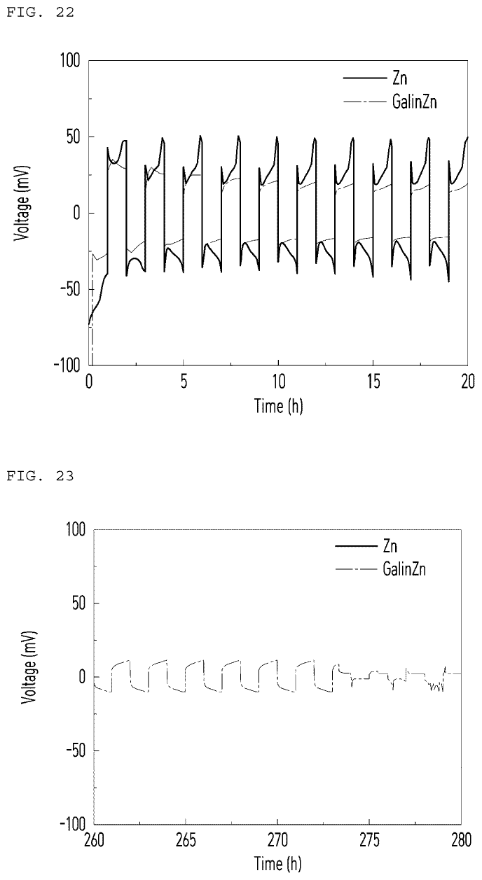

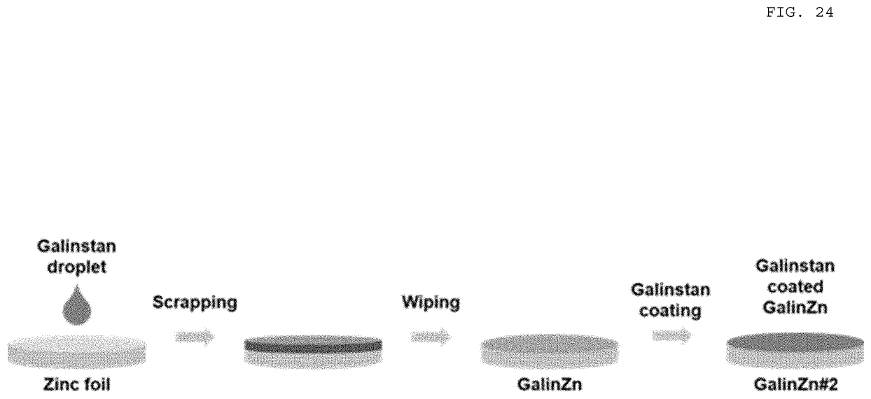

As another embodiment, FIG. 24 shows a process of additionally coating the completed GalinZn surface with Galinstan, unlike the existing GalinZn manufacturing method, to manufacture a new sample named ‘GalinZn #2’. First, Galinstan droplets were dropped on a zinc foil and then subjected to scraping and wiping steps to form GalinZn, and the surface was coated with Galinstan once again, thereby finally embodying a state in which only Galinstan exists on the surface.

This ‘Galinstan coated GalinZn’ manufacturing method can control the electrode characteristics in various ways by allowing Galinstan to mainly occupy the surface, unlike the existing GalinZn where Zn and Galinstan coexist on the surface. This is expected to contribute to improving the stability of the electrode surface or improving corrosion resistance, and it is considered that the characteristics of GalinZn #2 can be further optimized through various manufacturing conditions.

### Preparation Example 2-2: Symmetric Battery Configuration

In order to confirm the electrode long life characteristics through repeated Zn deposition/dissolution reactions, a symmetric battery in the form of a 2032 coin cell using GalinZn #2 as both the cathode and the anode was manufactured in FIG. 19. A glass fiber filter (GF/B, Whatman) was configured as the separator, and 2 M Zn(OTf)₂ was configured as the electrolyte. By arranging the same electrode material as the cathode and the anode, the stability of the GalinZn #2 electrode in the electrolyte environment can be intensively evaluated.

This is to confirm how long GalinZn #2 can stably maintain the deposition and dissolution reactions of Zn metal during repeated charge/discharge processes, and as a result, basic data for verifying the long life characteristics such as the electrode surface corrosion inhibition effect and low overpotential was secured.

### Experimental Example 2-1: Evaluation of Zinc Secondary Battery Anode Performance

FIG. 25 is a graph comparing repeated Zn deposition/dissolution behaviors of the Zn electrode (black) and the GalinZn #2 electrode (blue) for initial four hours under the conditions of 0.5 mA cm⁻² and 0.5 mAh cm⁻², and FIG. 26 is a graph comparing repeated Zn deposition/dissolution behaviors of the Zn electrode (black) and the GalinZn #2 electrode (blue) for 10 hours under the conditions of 0.5 mA cm⁻² and 0.5 mAh cm⁻². It can be confirmed that the voltage spike and overpotential due to Zn nucleation are greatly reduced in GalinZn #2, similar to the existing GalinZn, and this is considered to be a significant improvement effect compared to bare Zn.

That is, it is suggested that when the GalinZn #2 electrode is applied, the electrode surface is stabilized during the Zn deposition/desorption process, and thus the application thereof is suitable for securing long-life characteristics. This can be interpreted to be the result of maintaining stable voltage behaviors even during repeated charge and discharge by controlling the nucleation process of the Zn metal electrode and suppressing the increase in overpotential.

### Preparation Example 3-1: Manufacturing for Zinc Secondary Battery Composite Anode

In the case of the composite anode manufactured in the first and second embodiments above, it was able to confirm that it showed a remarkable effect compared to the prior art. However, additional examination was conducted on technical features that can be supplemented for devices having short circuits due to use for a long period of time.

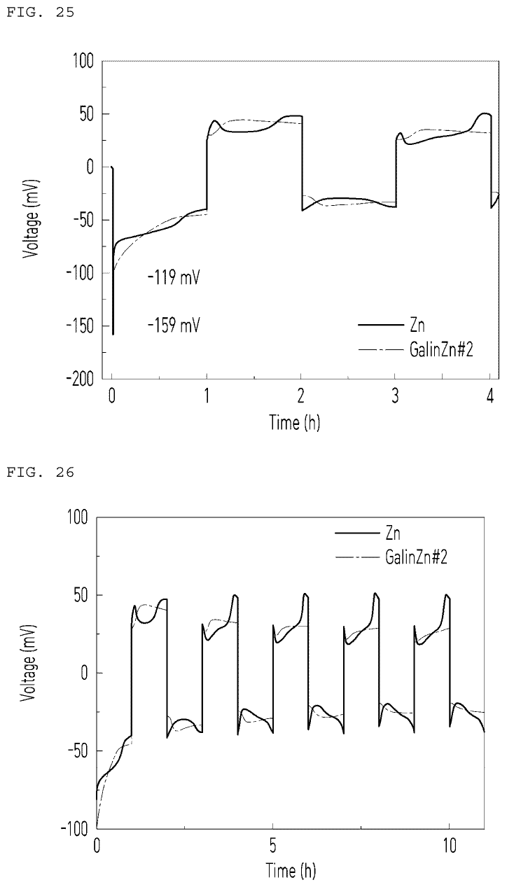

FIGS. 27 and 28 show results of analyzing a separator surface of a GalinZn device where a short circuit phenomenon occurred using SEM and EDS. It is presumed that the short circuit is caused by Galinstan intermittently climbing up the separator in the battery using GalinZn #1 or GalinZn #2, and actually, Ga, In, and Sn components were confirmed in addition to Zn in the separator region in the EDS spectrum, so it can be understood that Galinstan penetration occurred.

This suggests that a design is necessary to suppress the short circuit by applying an ion-permeable polymer coating such as PVA to the GalinZn electrode surface and performing encapsulation so as to protect the Galinstan layer in order to prevent the problem of Galinstan diffusing into the separator. In particular, the ratio of Ga:In:Sn was approximately 70.3:21.8:7.9 wt %, so the Galinstan components were detected without change on the separator, indicating the importance of an additional protective film or outer layer to improve electrode stability.

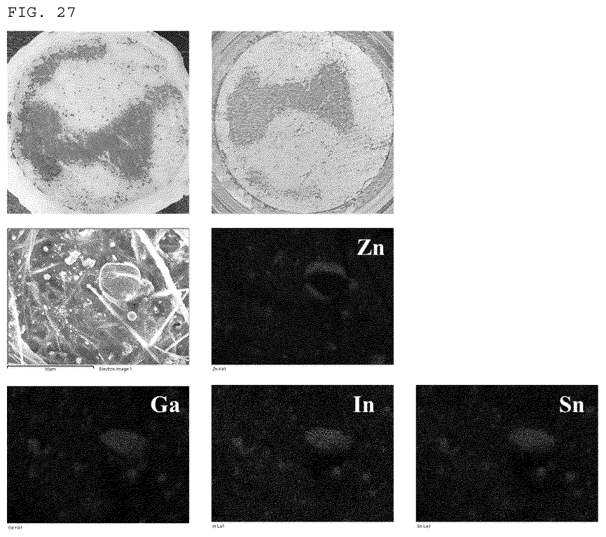

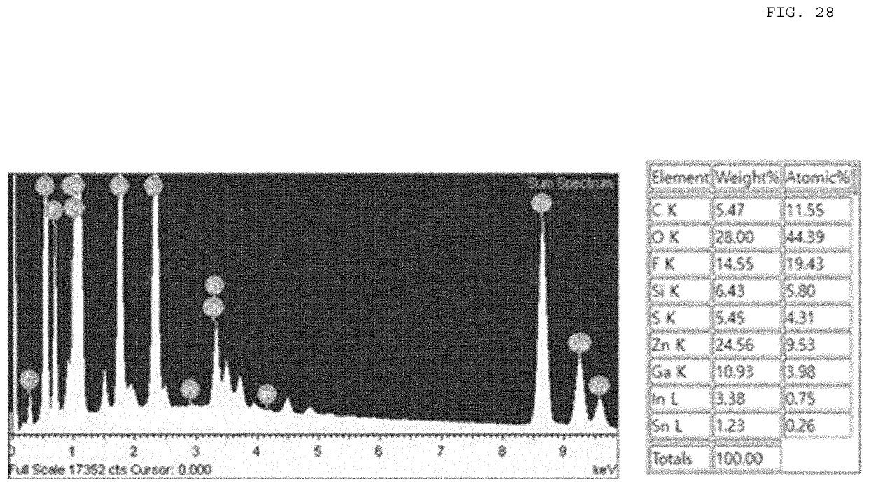

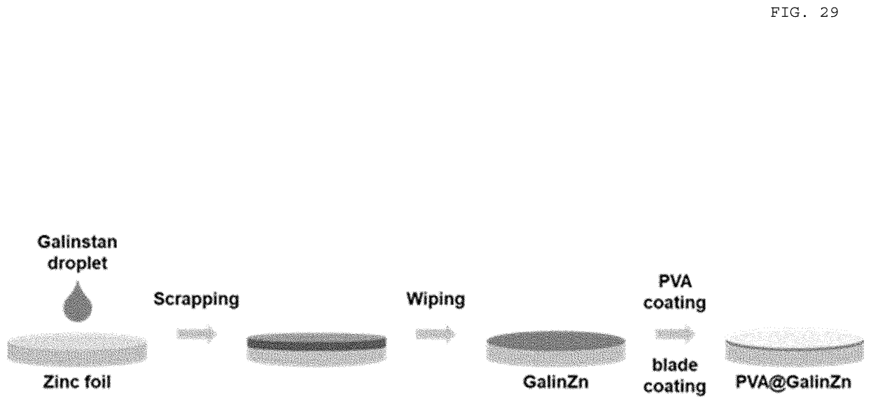

FIG. 29 shows a process of coating the surface of a GalinZn electrode with a polyvinyl alcohol (PVA) solution to manufacture PVA@GalinZn. First, a PVA solution (10 g of PVA+20 mL of H₂O) was prepared, then the Galinstan-Zn composite was attached onto the Parafilm (135 μm), blade-coating was performed to 320 μm (thickness of 10 μm) or 260 μm (thickness of 2 to 3 μm) depending on the coating thickness, and then it was dried at room temperature for about two hours to form the final PVA coating film. This was done to reduce direct exposure of Galinstan on the surface and to alleviate Galinstan penetration or short-circuit problems that may occur when using the electrode. The Zn-Galinstan composite manufactured in this manner is referred to as PVA@GalinZn in the present invention, and the correlation between the coating effect and the electrode characteristics can be confirmed by varying the PVA film thickness.

### Preparation Example 3-2: Symmetric Battery Configuration

In FIG. 19, a symmetric battery in the form of a 2032 coin cell using PVA@GalinZn for both the cathode and the anode was manufactured. In order to check the long life characteristics of the electrode through repeated Zn deposition/dissolution reactions, a glass fiber filter (GF/B, Whatman) was used as a separator, and 2 M Zn(OTf)₂ was applied as an electrolyte. Through this, it was possible to intensively evaluate whether PVA@GalinZn shows a stable reaction behavior in an electrolyte environment.

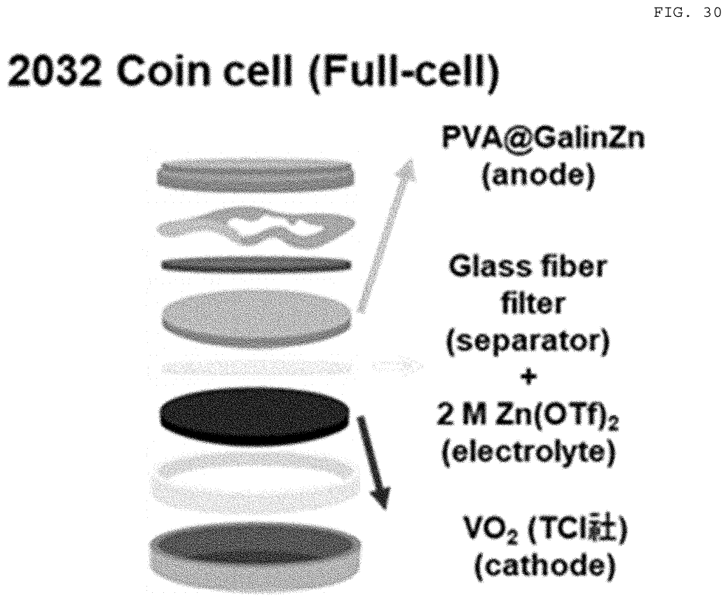

FIG. 30 shows a full cell configured to more clearly confirm expected effects of the PVA@GalinZn electrode. PVA@GalinZn was placed on the cathode of the full cell, and VO₂ (Tokyo Chemical Industry Co., Ltd.) was placed on the anode (or an electrode opposite to the cathode). Again, a glass fiber filter (GF/B, Whatman) was used as a separator, and 2 M Zn(OTf)₂ was applied as the electrolyte. At this time, the capacity and life characteristics were comprehensively analyzed to check the stability and the long life behavior of the PVA@GalinZn electrode during an actual battery operation.

### Experimental Example 3-1: Analysis of Corrosion Characteristics of Zinc Secondary Battery Anode

FIG. 31 shows corrosion test results for the Zn (black), GalinZn (blue), and PVA@GalinZn (red) electrodes as Tafel plots. The corrosion voltage (E_corr) of bare Zn was about −1.21 V, and the corrosion current (I_corr) was about 110.7 μA. However, in GalinZn and PVA@GalinZn, the corrosion voltages shifted to −1.14 V and −1.16 V, respectively, the corrosion currents were also measured to be about 6.4 μA and 6.1 μA, so it was confirmed that the corrosion currents were decreased about 20 times compared to those in bare Zn.

Through this, it can be understood that PVA@GalinZn to which PVA coating was applied also has corrosion resistance characteristics similar to GalinZn. Even when an additional outer layer is formed on the electrode surface, it is determined that the corrosion reaction is effectively suppressed to maintain the corrosion resistance characteristics. Therefore, it is expected that the PVA@GalinZn electrode manufactured by the present process will be able to maintain stable performance even when being used for a long period of time.

### Experimental Example 3-2: Evaluation of Zinc Secondary Battery Anode Performance

FIGS. 32 and 33 are graphs comparing repeated Zn deposition/dissolution behaviors appearing when PVA coatings of different thicknesses (2 μm and 10 μm) were applied to the Zn electrode and the GalinZn electrode under the conditions of 0.5 mA cm⁻² and 0.5 mAh cm⁻², FIG. 32 showing voltage changes over a long period of time (up to 3500 hours) and FIG. 33 showing voltage change for initial approximately four hours. When PVA coating having a thickness of 10 μm is applied to the Zn electrode, the overpotential increases, and the lifespan is slightly improved to about 20 hours, but failure still occurred in the long-term section. Meanwhile, when PVA is thinly coated (2 μm) on the GalinZn electrode, the overpotential increase is minimized, the lifespan is greatly improved, and therefore it can be confirmed that normal deposition/dissolution reaction proceeds for about 3050 hours or more.

This shows that the PVA coating effectively prevents direct contact between Galinstan and the separator, while enabling long lifespan by suppressing an increase in electrochemical resistance if the coating layer is not excessively thick. That is, when the Zn electrode is coated with PVA having a thickness of 10 μm, the overpotential is significantly increased, and the long-term characteristic improvement is limited. However, it can be understood that PVA coating (PVA@GalinZn) in a thickness of 2 μm on the GalinZn electrode secures long-term stability with a lower overpotential, and thus the durability of the electrode is maximized.

The referenced related art showed the long life characteristics of the Zn electrode according to the change in polymer coating thickness (16.5 to 12.3 to 9.4 and to 7.6 μm). The corresponding related art reported that thicker PVA coating acts as a protective layer between the Zn electrode and the electrolyte, thereby improving corrosion resistance and long-life characteristics.

Meanwhile, as a result of comparison with PVA@GalinZn according to one embodiment of the present application, it can be understood that GalinZn itself has excellent corrosion resistance compared to Zn, and thus long life characteristics can be secured even if the PVA film thickness is thinly adjusted. That is, the protective effect of the PVA coating alone tends to depend on the coating thickness, but if PVA coating is combined with GalinZn, the surface stabilization effect is increased, and thus durability required for long-term use can be secured even if the thickness is thin (less than 5 μm).

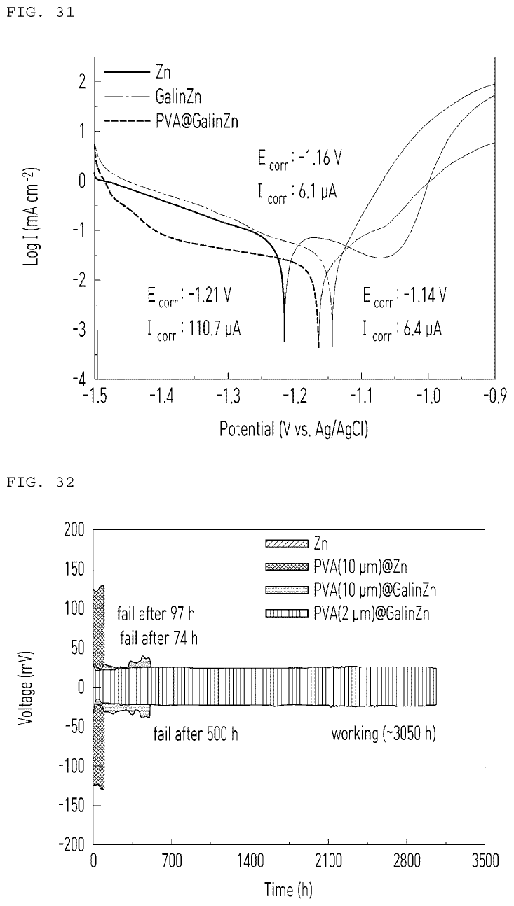

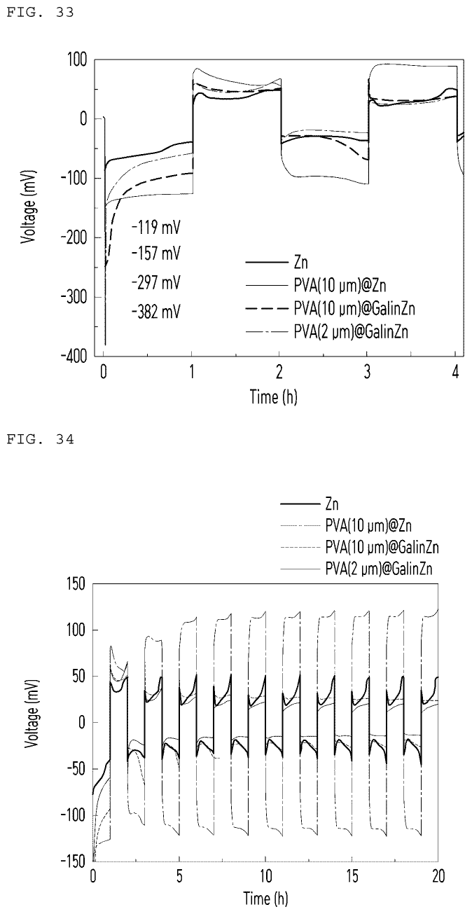

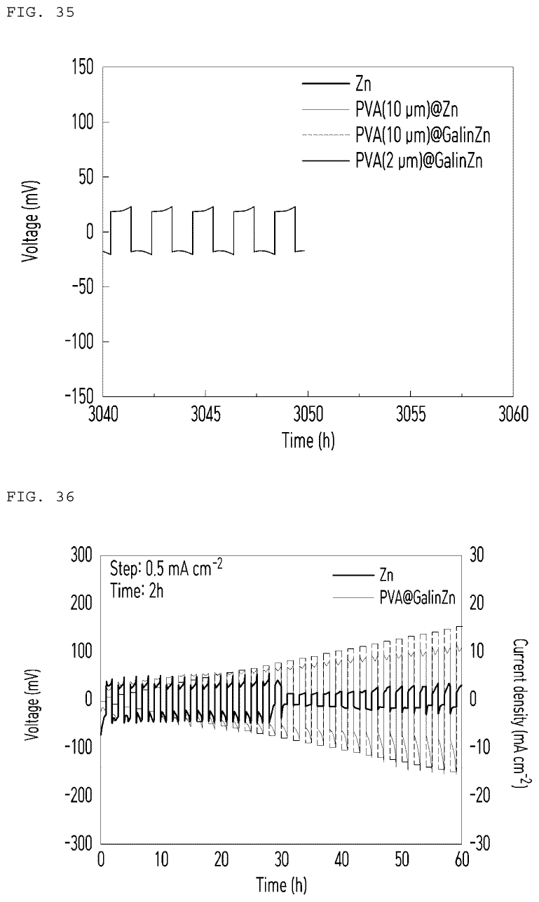

FIGS. 34 and 35 show results of comparing repeated Zn deposition/dissolution behaviors of the Zn electrode (black), PVA (10 μm) @Zn(blue), PVA (10 μm) @GalinZn (green), and PVA (2 μm) @GalinZn (red) under the conditions of 0.5 mA cm⁻² and 0.5 mAh cm⁻² in the short-term (FIG. 34) and long-term (FIG. 35) sections, respectively. When the Zn electrode was coated with PVA having a thickness of 10 μm, the overpotential is significantly increased initially and the lifespan was slightly improved to about 20 hours, but failure still occurred in the long-term section.

This means that the PVA coating can suppress the direct contact of Galinstan with the separator but cannot fundamentally solve the overpotential increase that occurs in the course of the nucleation or repeated deposition/dissolution of the Zn electrode. Meanwhile, when GalinZn is coated thinly with 2 μm of PVA, long-life characteristics (operation for about 3050 hours) can be embodied without a significant increase in overpotential, and thus it can be understood that GalinZn coated with PVA is more advantageous in securing electrode stability.

FIG. 36 shows results obtained by observing the Zn deposition/dissolution behaviors up to 15 mA cm⁻² by repeating (step) Zn deposition and dissolution for one hour under the same conditions for the Zn electrode (black) and the PVA@GalinZn electrode (red) and increasing the current density by 0.5 mA cm⁻² in each step. It was confirmed that the Zn electrode short-circuited at about 7.5 mA cm⁻², while the PVA@GalinZn electrode operated normally even at a high current density of 15 mA cm⁻².

This means that the PVA@GalinZn electrode has a high Zn affinity compared to Zn and thus can maintain a stable electrochemical reaction even under fast Zn deposition and dissolution conditions. That is, it suggests that short circuit or rapid potential change does not occur on the electrode surface even when the current density increases, and thus an electrode design with excellent durability even during high-speed charge and discharge can be achieved.

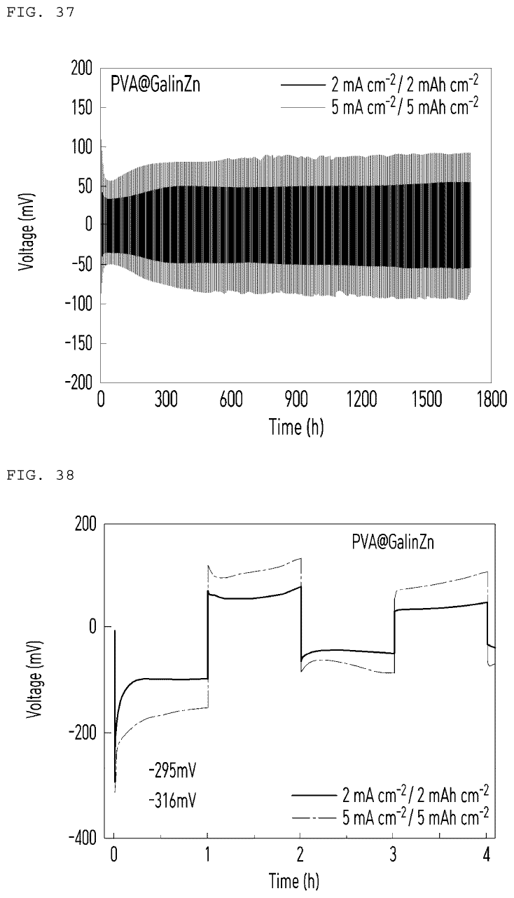

FIGS. 37 and 38 show results obtained by performing repeated Zn deposition/dissolution tests on the PVA@GalinZn electrode under the conditions of 2 mA cm⁻²/2 mAh cm⁻² and 5 mA cm⁻²/5 mAh cm⁻², the graph in FIG. 37 confirms the long-life characteristics that stably operate even after about 1700 hours, the graph in FIG. 38 shows that Zn deposition occurred at around −295 mV and −316 mV for initial four hours, and thus it is understood that stable behavior is shown under both current conditions.

This suggests that the PVA@GalinZn electrode can be operated stably for a long period of time even under relatively high current density and capacity conditions, and it is considered that the PVA coating formed on the electrode surface prevents direct contact between the separator and the Galinstan coating layer to act as a protective layer while effectively suppressing Zn nucleation and corrosion reaction to embody long-life characteristics.

### Experimental Example 3-3: In-situ Optical Spectral Analysis

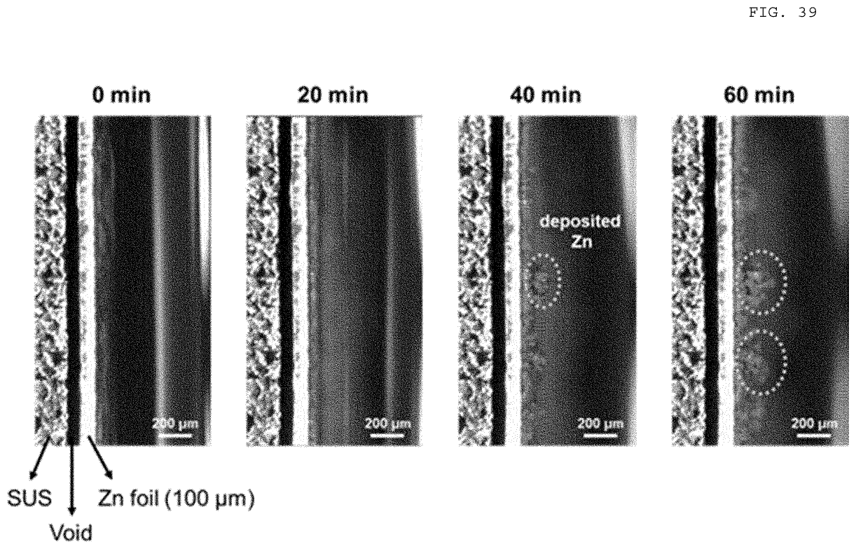

FIG. 39 shows results obtained by observing a bare Zn sample by in-situ optical spectroscopy, and a pattern in which Zn was deposited over time (0, 20, 40, and 60 minutes) at a current density of 10 mA cm-ª was observed. As a result of the observation, Zn was locally deposited on the bare Zn surface to show a spherical protrusion (dendrite) shape, indicating that the electrode surface was not uniform and Zn deposition was concentrated at a specific point.

As shown in the slide, it is considered that nucleation of zinc randomly occurs when bare Zn is used. This non-uniform deposition can cause electrode surface roughness and corrosion/short-circuit during charge/discharge for a long period of time, suggesting that uniform Zn deposition is essential.

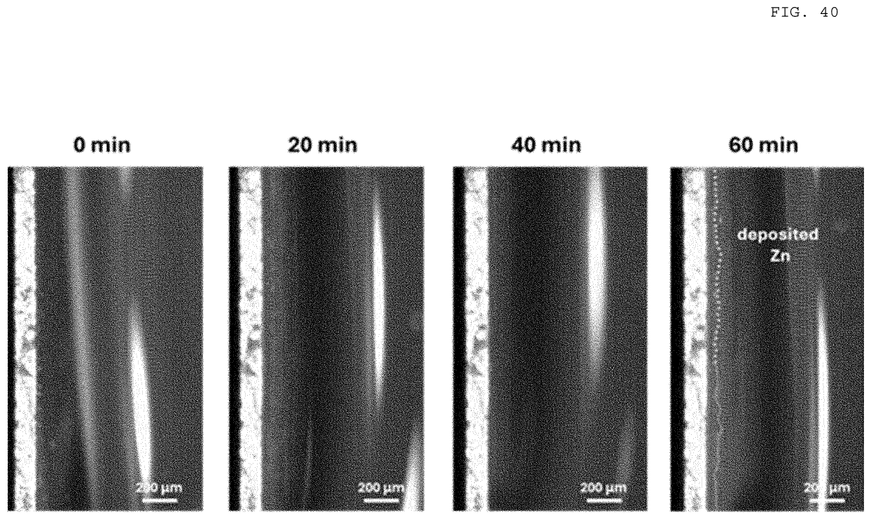

FIG. 40 shows results obtained by observing Zn deposition patterns over time (0, 20, 40, and 60 minutes) under the current density of 10 mA cm⁻² using the PVA@GalinZn electrode by in-situ optical spectroscopy. As a result of the observation, it is confirmed that unlike bare Zn, Zn is uniformly deposited in PVA@GalinZn, and the phenomenon of local deposition at a specific point is greatly suppressed.

This is considered that the composite coating of PVA and Galinstan stabilizes the electrode surface and helps Zn nucleation to evenly occur. As shown in the slide, the contact area with the electrolyte in the PVA@GalinZn electrode is uniformly maintained, and thus effects of increase in surface roughness, minimization of local corrosion, and the like even under long-term high-current conditions are expected.

### Experimental Example 3-4: Evaluation of Zinc Secondary Battery Anode Performance (Full-Cell Test)

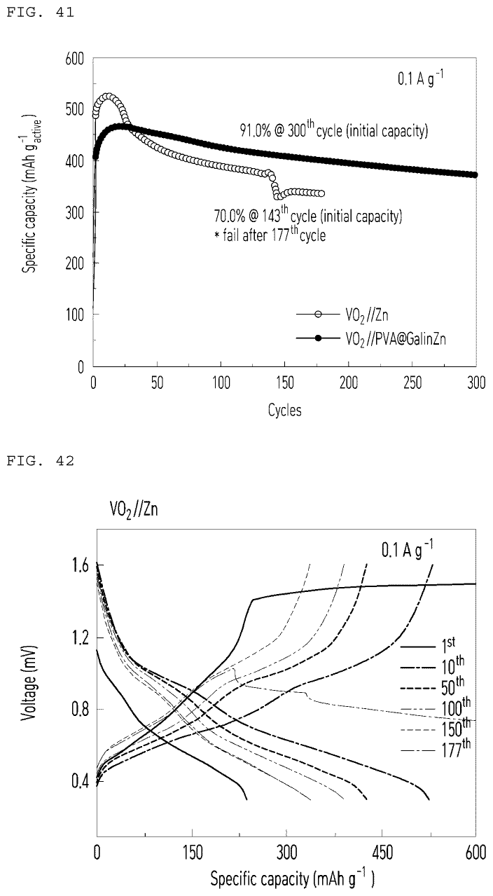

FIG. 41 shows changes in specific capacity according to the number of cycles in a full cell obtained by combining VO₂ (cathode) and Zn or PVA@GalinZn (anode). The capacity of the VO₂//Zn battery decreases to equal to less than 70% of the initial capacity after about 143 charge/discharge cycles, and the capacity thereof rapidly decreases after 177 charge/discharge cycles, while the capacity of the VO₂//PVA@GalinZn battery maintains 91.0% of the initial capacity even after 300 charge/discharge cycles, thus confirming the long-life characteristic. It is considered that this is because the PVA@GalinZn anode exhibits excellent corrosion resistance compared to Zn and uniform Zn insertion/dissolution behavior.

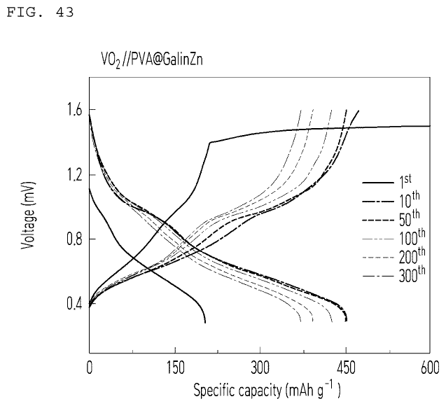

The graph of FIG. 42 shows the voltage-capacity curves from the first to the 177th charge/discharge cycles of the VO₂//Zn battery, and it can be understood that the voltage profile is drastically changed around the 177th cycle, indicating that battery performance is significantly decreased. Initially, a relatively high capacity is secured, but as the charge/discharge is repeated, the voltage plateau collapses and the capacity decay accelerates, leading to the battery operation ultimately failing at approximately the 177th cycle.

Meanwhile, the graph of FIG. 43 shows the voltage-capacity curves from the first to the 300th charge/discharge cycles of the VO₂//PVA@GalinZn battery, and it can be confirmed that a stable voltage plateau is maintained in each cycle and that long-term operation is possible. Even after 300 charge/discharge cycles, the battery maintains approximately 91.0% of the initial capacity, and thus it is suggested that the durability is significantly improved compared to bare Zn, which may be a result of the PVA@GalinZn anode inducing stable electrochemical reaction during the Zn insertion/dissolution process.

According to the example of the present invention, a zinc secondary battery composite anode can embody a zinc secondary battery with long life and high stability by effectively solving the corrosion problem of a conventional zinc (Zn) metal anode. In an anode material compositing Galinstan and Zn, Galinstan is formed between the grain boundaries of Zn. Therefore, corrosion resistance is excellent compared to conventional Zn, and the corrosion reaction is suppressed even in a weakly acidic electrolyte. As a result, the hydrogen evolution reaction (HER) and byproduct (ZHS) formation that occur with corrosion are minimized, and the growth of Zn dendrites can be effectively prevented. Accordingly, a zinc secondary battery to which the composite anode of the present invention is applied provides a significantly improved charge/discharge life compared to a conventional Zn anode and can stably operate even in an actual long-life experiment.

In addition, the composite anode according to one example of the present invention can be manufactured and applied in various ways, making it highly commercially available. This is similar to an existing lithium secondary battery electrode manufacturing method and thus provides an advantage of being easily applied to an existing battery manufacturing process. Furthermore, it can be seen that a coin cell manufactured by combining the composite anode of the present invention with a vanadium oxide-based cathode exhibits high capacity retention and stable performance, thereby exhibiting high practicality. Therefore, one example of the present invention can not only dramatically improve the performance of a zinc secondary battery, but also maximize the possibility of commercialization as a next-generation eco-friendly and highly stable secondary battery.

The effects of the present invention are not limited to the above effects and should be understood to include all effects that can be inferred from the configuration of the invention described in the description or claims of the present invention.

The above description of the present invention is for illustrative purposes only, and a person having ordinary skill in the art to which the present invention pertains will understand that the present invention can be easily modified into other specific forms without changing the technical idea or essential features thereof. Therefore, the examples described above should be understood as being exemplary and not limiting in all respects. For example, each component described as a single component may be embodied in a distributed manner, and likewise, components described as being distributed may be embodied in a combined manner.

The scope of the present invention is indicated by the claims described below, and all changes or modifications derived from the meaning and scope of the claims and their equivalent concepts should be interpreted as being included in the scope of the present invention.

What is claimed is:

1. A secondary battery composite anode, comprising:
a metal layer that includes a first metal; and
a liquid metal coating layer that is formed on the metal layer and includes a metal different from the first metal,
wherein the metal different from the first metal is included in a grain boundary of the first metal.

2. The secondary battery composite anode according to claim 1,
wherein the first metal is limited to a metal used in a secondary battery, and the metal is at least one selected from lithium, zinc, sodium, potassium, magnesium, calcium, or aluminum.

3. The secondary battery composite anode according to claim 1,
wherein the metal different from the first metal of the liquid metal coating layer is at least two selected from the group consisting of gallium (Ga), indium (In), tin (Sn), sodium (Na), lead (Pb), bismuth (Bi), potassium (K), and mercury (Hg).

4. The secondary battery composite anode according to claim 1,
wherein the liquid metal is Galinstan.

5. The secondary battery composite anode according to claim 1, further comprising:
a protective layer formed on the liquid metal coating layer.

6. The secondary battery composite anode according to claim 5,
wherein the protective layer is formed with a liquid metal.

7. The secondary battery composite anode according to claim 5, further comprising:
an outer layer on the protective layer.

8. The secondary battery composite anode according to claim 7,
wherein the outer layer is formed with an ion-permeable polymer.

9. The secondary battery composite anode according to claim 8,
wherein the ion-permeable polymer is at least one selected from polyvinyl alcohol (PVA), polyacrylamide (PAM), poly(styrene sulfonate) (PSS), polyethylene oxide (PEO), polyacrylic acid-based gel (Carbopol), polydopamine (PDA), polyaniline (PANI), polyimide (PI), polypyrrole (PPy), polyvinylidene fluoride (PVDF), polyvinylidene fluoride-hexafluoropropylene (PVDF-HFP), polyethylene glycol (PEG), polyvinylpyrrolidone (PVP), poly(2-hydroxyethyl methacrylate) (PHEMA), polyacrylic acid (PAA), carboxymethyl cellulose (CMC), polytetrafluoroethylene (PTFE), polymethyl methacrylate (PMMA), polyethyleneimine (PEI), chitosan, poly(2-acrylamido-2-methylpropanesulfonic acid) (PAMPS), sodium alginate, polystyrene (PS), polypropylene (PP), polycarbonate (PC), and polycaprolactam (PA6).

10. The secondary battery composite anode according to claim 1,
wherein a thickness of a byproduct layer formed at a topmost portion formed after the secondary battery composite anode is immersed in an electrolyte for 10 days may be less than 7 μm on average.

11. A method for manufacturing a secondary battery composite anode comprising:
a step of preparing a metal layer including a first metal;
a step of coating the metal layer with a liquid metal including a metal different from the first metal;
a step of scraping the coated liquid metal; and
a step of wiping a surface of the scraped metal layer to form a liquid metal coating layer.

12. The method for manufacturing a secondary battery composite anode according to claim 11, further comprising:
a step of forming a protective layer on the liquid metal coating layer after the step of wiping the surface of the scraped metal layer to form the liquid metal layer.

13. The method for manufacturing a secondary battery composite anode according to claim 12, further comprising:
a step of forming an outer layer formed with an ion-permeable polymer on the protective layer after the step of forming the protective layer on the liquid metal coating layer.

14. A secondary battery comprising:
a cathode;
the anode according to claim 1; and
an electrolyte.
